(19) United States
(12) Patent Application Publication
(10) Pub. No.: US 2024/0152295 A1
(43) Pub. Date: May 9, 2024

(54) PEAK POWER MANAGEMENT WITH DYNAMIC DATA PATH OPERATION CURRENT BUDGET MANAGEMENT

(71) Applicant: Micron Technology, Inc., Boise, ID (US)

(72) Inventors: Liang Yu, Boise, ID (US); Jonathan S. Parry, Boise, ID (US)

(21) Appl. No.: 18/503,246

(22) Filed: Nov. 7, 2023

Related U.S. Application Data
(60) Provisional application No. 63/423,663, filed on Nov. 8, 2022.

(51) Int. Cl. G06F 3/06

(52) U.S. Cl. CPC G06F 3/0659; G06F 3/0604; G06F 3/0631; G06F 3/0679

(57) ABSTRACT

A memory device includes a plurality of memory dies, each memory die of the plurality of memory dies including a memory array and control logic, operatively coupled with the memory array, to perform operations including identifying a data path operation with respect to the memory die. The memory die is associated with a channel. The operations further include determining, based on at least one value derived from a current budget ready status and a cache ready status, whether the channel is ready for the memory die to handle the data path operation, and in response to determining that the channel is ready for the memory die to handle the data path operation, causing the data path operation to be handled by the memory die.

### CROSS-REFERENCE TO RELATED APPLICATION(S)

This application claims the benefit of U.S. Provisional Application 63/423,663, filed on Nov. 8, 2022 and entitled “PEAK POWER MANAGEMENT WITH DYNAMIC DATA PATH OPERATION CURRENT BUDGET MANAGEMENT”, the entire contents of which are incorporated by reference herein.

### TECHNICAL FIELD

Embodiments of the disclosure relate generally to memory sub-systems, and more specifically, relate to implementing peak power management (PPM) with dynamic data path operation current budget management.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1A illustrates an example computing system that includes a memory sub-system in accordance with some embodiments of the present disclosure.

FIG. 1B is a block diagram of a memory device in communication with a memory sub-system controller of a memory sub-system in accordance with some embodiments of the present disclosure.

FIGS. 2A-2C are diagrams of portions of an example array of memory cells included in a memory device, in accordance with some embodiments of the present disclosure.

FIG. 3 is a block diagram illustrating a multi-die package with multiple memory dies in a memory sub-system, in accordance with some embodiments of the present disclosure.

FIG. 4 is a block diagram illustrating a multi-plane memory device configured for independent parallel plane access, in accordance with some embodiments of the present disclosure.

FIGS. 5-8B are diagrams illustrating example implementations of peak power management (PPM) with dynamic data path operation current budget management, in accordance with some embodiments of the present disclosure.

FIG. 9 is a diagram illustrating an example status register bit and budget threshold interaction, in accordance with some embodiments of the present disclosure.

FIG. 10 is a flow diagram of a method to implement peak power management (PPM) with dynamic data path operation current budget management, in accordance with some embodiments of the present disclosure.

FIG. 11 is a block diagram of an example computer system in which embodiments of the present disclosure may operate.

### DETAILED DESCRIPTION

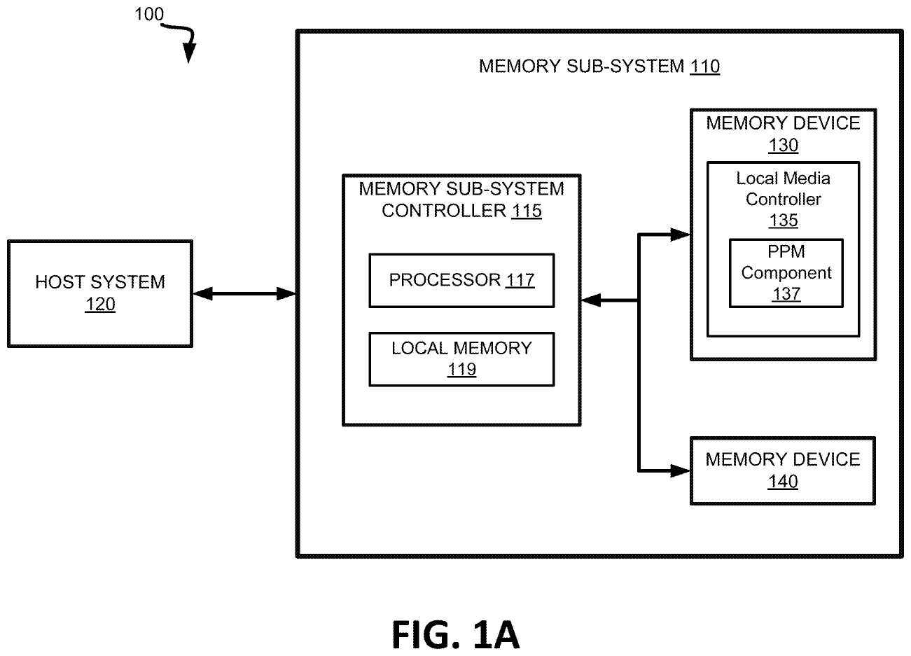

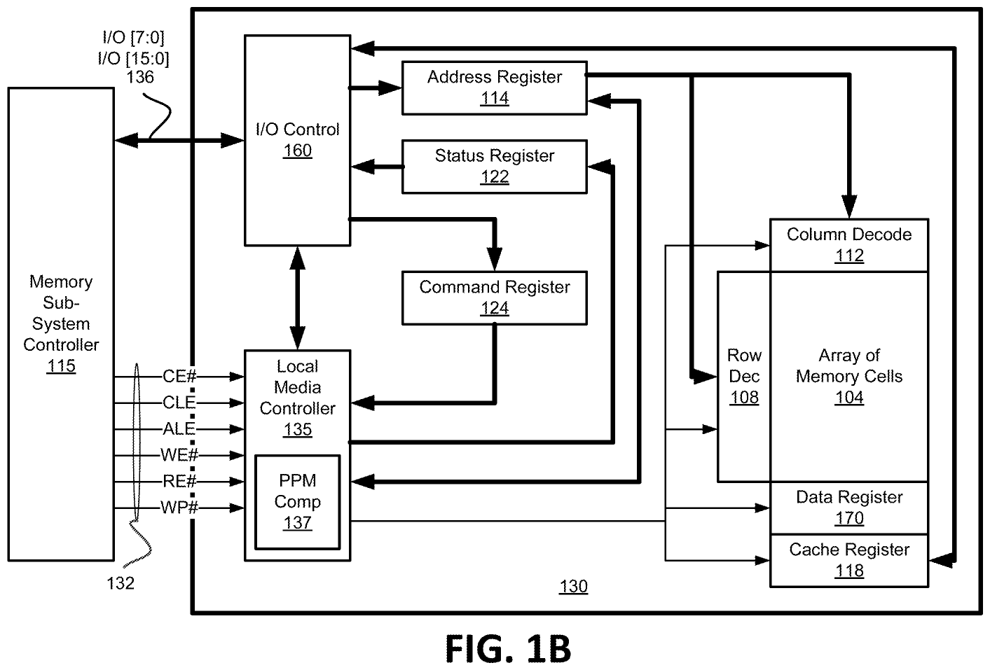

Aspects of the present disclosure are directed to implementing peak power management (PPM) with dynamic data path operation current budget management. A memory sub-system can be a storage device, a memory module, or a combination of a storage device and memory module. Examples of storage devices and memory modules are described below in conjunction with FIGS. 1A-1B. In general, a host system can utilize a memory sub-system that includes one or more components, such as memory devices that store data. The host system can provide data to be stored at the memory sub-system and can request data to be retrieved from the memory sub-system.

A memory sub-system can include high density non-volatile memory devices where retention of data is desired when no power is supplied to the memory device. One example of non-volatile memory devices is a negative-and (NAND) memory device. Other examples of non-volatile memory devices are described below in conjunction with FIGS. 1A-1B. A non-volatile memory device is a package of one or more dies. Each die can consist of one or more planes. For some types of non-volatile memory devices (e.g., NAND devices), each plane consists of a set of physical blocks. Each block consists of a set of pages. Each page consists of a set of memory cells. A memory cell is an electronic circuit that stores information. Depending on the memory cell type, a memory cell can store one or more bits of binary information, and has various logic states that correlate to the number of bits being stored. The logic states can be represented by binary values, such as “0” and “1”, or combinations of such values.

A memory device can include multiple memory cells arranged in a two-dimensional or three-dimensional grid. The memory cells are formed onto a silicon wafer in an array of columns (also hereinafter referred to as bitlines) and rows (also hereinafter referred to as wordlines). A wordline can refer to one or more conductive lines of a memory device that are used with one or more bitlines to generate the address of each of the memory cells. The intersection of a bitline and wordline constitutes the address of the memory cell. A block hereinafter refers to a unit of the memory device used to store data and can include a group of memory cells, a wordline group, a wordline, or individual memory cells. One or more blocks can be grouped together to form a plane of the memory device in order to allow concurrent operations to take place on each plane. The memory device can include circuitry that performs concurrent memory page accesses of two or more memory planes. For example, the memory device can include a respective access line driver circuit and power circuit for each plane of the memory device to facilitate concurrent access of pages of two or more memory planes, including different page types. For ease of description, these circuits can be generally referred to as independent plane driver circuits. Control logic on the memory device includes a number of separate processing threads to perform concurrent memory access operations (e.g., read operations, program operations, and erase operations). For example, each processing thread corresponds to a respective one of the memory planes and utilizes the associated independent plane driver circuits to perform the memory access operations on the respective memory plane. As these processing threads operate independently, the power usage and requirements associated with each processing thread also varies.

A memory device can be a three-dimensional (3D) memory device. For example, a 3D memory device can be a three-dimensional (3D) replacement gate memory device (e.g., 3D replacement gate NAND), which is a memory device with a replacement gate structure using wordline stacking. For example, a 3D replacement gate memory device can include wordlines, select gates, etc. located between sets of layers including a pillar (e.g., polysilicon pillar), a tunnel oxide layer, a charge trap (CT) layer, and a dielectric (e.g., oxide) layer. A 3D replacement gate memory device can have a “top deck” corresponding to a first side and a “bottom deck” corresponding to a second side. For example, the first side can be a drain side and the second side can be a source side. Data in a 3D replacement gate memory device can be stored as 1 bit/memory cell (SLC), 2 bits/memory cell (MLC), 3 bits/memory cell (TLC), etc.

Various access lines, data lines and voltage nodes can be charged or discharged very quickly during sense (e.g., read or verify), program, and erase operations so that memory array access operations can meet the performance specifications that are often required to satisfy data throughput targets as might be dictated by customer requirements or industry standards, for example. For sequential read or programming, multi-plane operations are often used to increase the system throughput. As a result, a memory device can have a high peak current usage, which might be four to five times the average current amplitude. Thus, with such a high average market requirement of total current usage budget, it can become challenging to concurrently operate more than a certain number of memory dies (“dies”) of a memory device.

Peak power management (PPM) can be utilized as a technique to manage power consumption of a memory device containing multiple dies, many of which rely on a controller to stagger the activity of the dies seeking to avoid performing high power portions of memory access operations concurrently in more than one die. A PPM system can implement a PPM communication protocol, which is an inter-die communication protocol that can be used for limiting and/or tracking current or power consumed by each die. Each die can include a PPM component that exchanges information with its own local media controller (e.g., NAND controller) and other PPM components of the other dies via a communication bus. Each PPM component can be configured to perform power or current budget arbitration for the respective die. For example, each PPM component can implement predictive PPM to perform predictive power budget arbitration for the respective memory device.

The PPM communication protocol can employ a token-based round robin protocol, whereby each PPM component rotates as a holder of a PPM token in accordance with a token circulation time period. Circulation of the token among the memory devices can be controlled by a common clock signal (“ICLK”). For example, the dies can include a designated primary die that generates the common clock signal received by each active PPM component, with the remaining dies being designated as secondary dies. The token circulation time period can be defined by a number of clock cycles of the common clock signal, and the memory device can pass the token to the next memory device after the number of clock cycles has elapsed.

A die counter can be used to keep track of which die is holding the token. Each die counter value can be univocally associated with a respective die by utilizing a special PPM address for each die. The die counter can be updated upon the passing of the token to the next die.

While holding the token, the PPM component broadcasts, to the other dies, information encoding the amount of current used by its respective die during a given time period (e.g., a quantized current budget). The information can be broadcast using a data line. For example, the data line can be a high current (HC #) data line. The amount of information can be defined by a sequence of bits, where each bit corresponds to the logic level of a data line signal (e.g., an HC # signal) at a respective clock cycle (e.g., a bit has a value of “0” if the HC # signal is logic low during a clock cycle, or a value of “1” if the clock pulse is logic high during a clock cycle). For example, if a die circulates the token after three clock cycles, then the information can include three bits. More specifically, a first bit corresponds to the logic level of the HC #signal during a first clock cycle, a second bit corresponds to the logic level of the HC # signal during a second clock cycle, and a third bit corresponds to the logic level of the HC # signal during the third clock cycle. Accordingly, the token circulation time period (e.g., number of clock cycles) can be defined in accordance with the amount of information to be broadcast by a holder of the token (e.g., number of bits).

While holding the token, the PPM component can issue a request for a certain amount of current to be reserved in order to execute a memory access operation. The system can have a designated maximum current budget, and at least a portion of the maximum current budget may be currently reserved for use by the other memory dies. Thus, an available current budget can be defined as the difference between the maximum current budget and the total amount of reserved current budget during the current token circulation cycle. If the amount of current of the request is less than or equal to the available current budget during the current cycle, then the request is granted and the local media controller can cause the memory access operation to be executed. Otherwise, if the amount of current of the new request exceeds the available current budget, then the local media controller can be forced to wait for sufficient current budget to be made available by the other die(s) to execute the memory access operation (e.g., wait at least one current token circulation cycle).

Each PPM component can maintain the information broadcast by each die (e.g., within respective registers), which enables each die to calculate the current consumption. For example, if there are four dies Die 0 through Die 3, each Die 0 through Die 3 can maintain information broadcast by Die 0 through Die 3 within respective registers designated for Die 0 through Die 3. Since each of Die 0 through Die 3 maintains the maximum current budget the most updated current consumption, each of Die 0 through Die 3 can calculate the available current budget. Accordingly, each of Die 0 through Die 3 can determine whether there is a sufficient amount of available current budget for its local media controller to execute a new memory access operation.

A memory access operation (e.g., program operation, read operation or erase operation) can include multiple sub-operations arranged in an execution sequence. For example, the sub-operations can include an initial sub-operation to initiate the memory access operation, a final sub-operation to complete the memory access operation. The sub-operations can further include at least one intermediate sub-operation performed between the initial sub-operation and the final sub-operation. For each sub-operation, for the local media controller to determine whether there is sufficient available current budget to proceed with execution of the sub-operation, the sub-operation can be assigned a current breakpoint. Each current breakpoint is defined (e.g., as a PPM parameter during initialization of PPM) at the beginning of its respective sub-operation to indicate whether the sub-operation will consume more current, less current, or the same amount of current as the previous sub-operation. Accordingly, current breakpoints can be used as a gating mechanism to control execution of a memory access operation.

For example, a high current (HC) breakpoint indicates that its respective sub-operation will be consuming an amount of current that is greater than the amount of current consumed to execute the previous sub-operation. Thus, the PPM component may have to reserve additional current to enable the local media controller to execute the sub-operation. For example, a first HC breakpoint can be defined with respect to an initial sub-operation of the memory access operation, since the initial sub-operation will necessarily consume a greater amount of current than the zero amount of current that was being consumed immediately before requesting execution of the memory access operation. Upon reaching a HC breakpoint, the local media controller can communicate, with the PPM component, the amount of current that the memory device will be consuming to execute the respective sub-operation. The local media controller waits to receive a response (e.g., flag) indicating that there is sufficient available current budget that can be reserved for executing the respective sub-operation. Upon receiving the response from that PPM component that there is sufficient available current budget that can be reserved for executing the respective sub-operation, the local media controller can proceed with executing the respective sub-operation. Accordingly, the local media controller will execute a sub-operation at a HC breakpoint only if the PPM component indicates that there is sufficient available current in the current budget to do so.

In contrast to a HC breakpoint, a low current (LC) breakpoint indicates that its respective sub-operation will be consuming an amount of current that is less than or equal to the amount of current consumed to execute the previous sub-operation. Since the PPM component had already reserved enough current for executing the previous sub-operation, the local media controller will, upon reaching a LC breakpoint, proceed with executing the respective sub-operation using at least a portion of the already reserved current. However, the local media controller still communicates, with the PPM component, the amount of current that the memory device will be consuming to perform the sub-operation. For example, the PPM component can release an unused portion of the reserved current for the other dies.

Illustratively, if the memory access operation is a read operation, then the read operation can include a prologue sub-operation as the initial sub-operation, a read initialization sub-operation following the prologue sub-operation, a sensing sub-operation following the read initialization sub-operation, and a read recovery sub-operation following the sensing sub-operation. Respective HC breakpoints can be defined for the prologue sub-operation (as the initial sub-operation) and the read initialization sub-operation (since the read initialization sub-operation consumes more current than the prologue sub-operation). Respective LC breakpoints can be defined for the sensing sub-operation (since the sensing sub-operation does not consume more current than the read initialization sub-operation) and the read recovery sub-operation (since the read recovery sub-operation does not consume more current than the sensing sub-operation).

The memory sub-system can include a memory device interface between the memory sub-system controller and a memory device (e.g., NAND memory device) to process multiple different signals relating to one or more transfers or communications with the memory device. For example, the interface can process signals relating to memory access commands (e.g., command/address cycles) to configure the memory device to enable the transfer of raw data in connection with a memory access operation (e.g., a read operation, a program operation, etc.). The interface can implement a multiplexed interface bus including bidirectional input/output (I/O) pins that can transfer address, data and instruction information between the memory sub-system controller and the memory device (e.g., local media controller and I/O control). The I/O pins can be output pins during read operations, and input pins at other times. For example, the interface bus can be an 8-bit bus (I/O [7:0]) or a 16-bit bus (I/O [15:0]).

The interface can further utilize a set of command pins to implement interface protocols. For example, the set of command pins can include a Chip Enable (CE #) pin, an Address Latch Enable (ALE) pin, a Command Latch Enable (CLE) pin, a Write Enable (WE #) pin, a Read Enable (RE #) pin, a data strobe signal (DQS) pin. Additional pins can include, for example, a write protection (WP #) pin that controls hardware write protection, and a ready/busy (RB #) pin that monitors device status and indicates the completion of a memory access operation (e.g., whether the memory device is ready or busy).

The “#” notation indicates that the CE #, WE #, #RE and WP #pins are active when set to a logical low state (e.g., 0 V), also referred to as “active-low” pins. Therefore, the ALE, CLE and DQS pins are active when set to a logical high state (e.g., greater than 0 V), also referred to as “active-high” pins. Asserting a pin can include setting the logical state of the pin to its active logical state, and de-asserting a pin can include setting the logical state of the pin to its inactive logical state. For example, an active-high pin is asserted when set to a logical high state (“driven high”) and de-asserted when set to a logical low state (“driven low”), while an active-low pin is asserted when to set to a logical low state (“driven low”) and de-asserted when set to a logical high state (“driven high”).

CE #, WE #, RE #, CLE, ALE and WP #signals are control signals that can control read and write operations. For example, the CE #pin is an input pin that gates transfers between the host system and the memory device. For example, when the CE #pin is asserted and the memory device is not in a busy state, the memory device can accept command, data and address information. When the memory device is not performing an operation, the CE #pin can be de-asserted.

The RE #pin is an input pin that gates transfers from the memory device to the host system. For example, data can be transferred at the rising edge of RE #. The WE #pin is an input pin that gates transfers from the host system to the memory device. For example, data can be written to a data register on the rising edge of WE # when CE #, CLE and ALE are low and the memory device is not busy.

The ALE pin and the CLE pin are respective input pins. When the ALE pin is driven high, address information can be transferred from the bus into an address register of the memory device upon a low-to-high transition on the WE #pin. More specifically, addresses can be written to the address register on the rising edge of WE # when CE # and CLE are low, ALE is high, and the memory device is not busy. When address information is not being loaded, the ALE pin can be driven low. When the CLE pin is driven high, information can be transferred from the bus to a command register of the memory device. More specifically, commands can be written to the command register on the rising edge of WE # when CE # and ALE are low, CLE is high, and the memory device is not busy. When command information is not being loaded, the CLE pin can be driven low. Accordingly, a high CLE signal can indicate that a command cycle is occurring, and a high ALE signal can indicate that an address input cycle is occurring.

Some memory device operations can be memory array operations. Examples of memory array operations include read operations and write operations. For example, ICC1 can refer to the VCC active current for sequential read operations, and ICC2 can refer to the VCC active current for program operations. Some memory device operations can be data path operations for data paths into, or out of, the memory array (e.g., a data path read operation or a data path write operation). For example, ICC4 can refer to the VCC active current for data path operations (e.g., ICC4R for read operations and ICC4 W for write operations).

One type of data path operation is a data burst. A data burst refers to a continuous set of data input or data output transfer cycles that are performed without pause via the data path into or out of the memory array. A data burst can be initiated by specifying a set of parameters including a starting memory address from where to begin the data transfer, and an amount of data to be transferred. After the data burst is initiated, it runs to completion, using as many interface bus transactions as necessary to transfer the amount of data designated by the set of parameters. Due at least in part to specifying the set of parameters, the data burst process can generate an overhead penalty with respect to pre-transfer instruction execution. However, since the data burst can continue without any processor involvement after the initiation, processing resources can be freed up for other tasks. One example of a data burst is a read burst. Another example of a data burst is a write burst.

A plurality of dies can be grouped into respective sets of dies, where each set of dies corresponds to a respective memory channels (“channels”) collectively controlled by a controller. Each die of the plurality of dies can correspond to a respective logical unit number (LUN). More specifically, a memory device interface disposed between the controller and the plurality of dies may interpret command packets and provide control signals, address and/or data information to a target die via a specified channel based on the command packets. For each channel, a respective channel control circuit can be operatively coupled to the respective set of dies via a bus for controlling the set of dies. For example, the memory device interface and/or bus can operate under an Open NAND Flash Interface Working Group (ONFI) protocol.

Although memory array operations are typically managed by the PPM protocol described above, data path operations are typically not managed by the PPM protocol. To address this, some systems can pre-reserve, from the available current budget, an amount of current to handle data path operations. More specifically, each channel can be statically assigned a respective amount of current to handle data path operations. The remaining available current budget can be made available to handle the memory array operations, and managed via the PPM protocol.

However, the pre-reserved amount current assigned to the plurality of channels can be determined in accordance with a worst-case scenario assumption regarding the predetermined amount of bus current consumption. In such situations, a potentially large portion of the pre-reserved amount of data path operation current budget can be wasted, which can unnecessarily limit the remaining amount of memory array operation current budget available to the dies to handle memory array operations. This can force dies to wait for current budget to be made available to handle memory array operations in accordance with the PPM protocol. Accordingly, the static data path operation current budget pre-reservation scheme can negatively impact memory array operation performance by causing dies to potentially wait for current budget to be released to handle memory array operations.

Aspects of the present disclosure address the above and other deficiencies by implementing PPM with dynamic data path operation current budget management. Embodiments described herein can enable more efficient management and reservation of data path operation current budget, which can improve system performance (e.g., PPM operation efficiency and system bandwidth). More specifically, embodiments described herein can be used to dynamically assign and/or release current budget reserved for incoming data path operations (e.g., data bursts). For example, embodiments described herein can pre-reserve an amount of data path operation current budget for a single channel of the plurality of channels, and dynamically assign and/or release the data path current budget with respect to each of the plurality of channels. This can enable more current budget to be allocated to memory array operations, which can reduce the amount of time that dies spend waiting for current budget to be released to perform memory array operations. Accordingly, embodiments described herein can enable more efficient utilization of the available current budget to improve overall system performance.

In accordance with one aspect, embodiments described herein can provide for an application-specific integrated circuit (ASIC). The ASIC can be configured to stagger bus current reservation for handling incoming data bursts by polling values of a set of status register bits provided by each die. The set of status register bits can provide at least one value associated with a current budget ready status and a cache ready status.

In some embodiments, the set of status register bits includes a current budget ready status register bit and a cache ready status register bit (i.e., a ready/busy status register bit). The current budget ready status register bit can be an extended status register bit. The value of the current budget ready status register bit can indicate whether the data path operation current budget, assigned to a channel, is ready for an incoming data path operation (e.g., data burst). The current budget ready status register bit is synchronized across all dies of a given channel. For example, if the value of the current budget ready status register bit is a reset value (e.g., “0”), this indicates that there is insufficient available data path operation current budget assigned to the channel to handle a data path operation (e.g., data burst). If the value of the current budget ready status register bit is a set value (e.g., “1”), this indicates that there is sufficient available data path operation current budget assigned to the channel to handle a data path operation.

The value of the cache ready status register bit can indicate whether an internal cache is ready for handling a data path operation (e.g., data burst). For example, the cache ready status register bit can correspond to pin SR[6]. The value of the cache ready status register bit can correspond to the value of the ready/busy signal (RB #). More specifically, a first value of the cache ready status register bit can indicate “busy” (e.g., “0”), while a second value of the cache ready status register bit can indicate “ready”) (e.g., “1”). Accordingly, the cache ready status register bit can return the second value when the internal cache is available to receive new data.

To determine whether to execute a command for an incoming data path operation with respect to a die of a channel, the ASIC can perform status register polling. More specifically, the ASIC can check the value of the current budget ready status register bit and the value of the cache ready status register bit for the die. The ASIC can determine whether the values of the current budget ready status register bit and the cache ready status register bit are both ready values (e.g., “1”). In response to determining that the values of the current budget ready status register bit and the cache ready status register bit are both ready values, the ASIC can cause the command for the incoming data path operation to be executed. Otherwise, the ASIC can continue performing status register polling until the values of the current budget ready status register bit and the cache ready status register bit are both ready values.

In some embodiments, the set of status register bits includes a modified cache ready status register bit. The memory device can internally provide the modified cache ready status register bit based on the cache ready status and the current budget ready status. More specifically, the memory device can implement AND logic, such that the modified cache ready status register bit will provide a ready value when both the cache ready status and the budget ready status are both ready (e.g., the modified cache ready status register bit has a value of “1”). To determine whether to execute a command for an incoming data path operation with respect to a die of a channel, the ASIC can perform status register polling. More specifically, the ASIC can check the value corresponding to the modified cache ready status register bit for the die. The ASIC can determine whether the value corresponding to the modified cache ready status register bit is a ready value (e.g., “1”). In response to determining that the value corresponding to the modified cache ready status register bit is a ready value, the ASIC can cause the command for the incoming data path operation to be executed. Otherwise, the ASIC can continue performing status register polling until the value corresponding to the modified cache ready status register bit is a ready value.

In accordance with another aspect, embodiments described herein can provide for a PPM component that includes logic to maintain a set of peak power states. For example, the set of peak power states can include a default power state and a boosted power state. By default, the PPM group can control dies within the PPM group using the default power state. When a new bus event occurs, the PPM group can control dies within the PPM group using the boosted power state. While in the boosted power state, memory array operations can automatically slow down (based on the PPM protocol) to make the PPM group return to the default power state. Once the PPM group returns to the default power state, this can enable the PPM group to handle another bus event from the ASIC described above. By doing so, the PPM group can handle bus events while preventing overbudget, and bus events can be treated as high priority events without delay. Further details regarding implementing PPM with dynamic data path operation current budget management will be described in further detail below with reference to FIGS. 1A-11.

Advantages of the present disclosure include, but are not limited to, improved memory sub-system performance and QoS. For example, embodiments described herein can improve PPM operation efficiency and system bandwidth.

FIG. 1A illustrates an example computing system 100 that includes a memory sub-system 110 in accordance with some embodiments of the present disclosure. The memory sub-system 110 can include media, such as one or more volatile memory devices (e.g., memory device 140), one or more non-volatile memory devices (e.g., memory device 130), or a combination of such.

A memory sub-system 110 can be a storage device, a memory module, or a combination of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory modules (NVDIMMs).

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include a host system 120 that is coupled to one or more memory sub-systems 110. In some embodiments, the host system 120 is coupled to multiple memory sub-systems 110 of different types. FIG. 1A illustrates one example of a host system 120 coupled to one memory sub-system 110. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

The host system 120 can include a processor chipset and a software stack executed by the processor chipset. The processor chipset can include one or more cores, one or more caches, a memory controller (e.g., NVDIMM controller), and a storage protocol controller (e.g., PCIe controller, SATA controller). The host system 120 uses the memory sub-system 110, for example, to write data to the memory sub-system 110 and read data from the memory sub-system 110.

The host system 120 can be coupled to the memory sub-system 110 via a physical host interface. Examples of a physical host interface include, but are not limited to, a serial advanced technology attachment (SATA) interface, a peripheral component interconnect express (PCIe) interface, universal serial bus (USB) interface, Fibre Pillar, Serial Attached SCSI (SAS), a double data rate (DDR) memory bus, Small Computer System Interface (SCSI), a dual in-line memory module (DIMM) interface (e.g., DIMM socket interface that supports Double Data Rate (DDR)), etc. The physical host interface can be used to transmit data between the host system 120 and the memory sub-system 110. The host system 120 can further utilize an NVM Express (NVMe) interface to access components (e.g., memory devices 130) when the memory sub-system 110 is coupled with the host system 120 by the physical host interface (e.g., PCIe bus). The physical host interface can provide an interface for passing control, address, data, and other signals between the memory sub-system 110 and the host system 120. FIG. 1A illustrates a memory sub-system 110 as an example. In general, the host system 120 can access multiple memory sub-systems via a same communication connection, multiple separate communication connections, and/or a combination of communication connections.

The memory devices 130, 140 can include any combination of the different types of non-volatile memory devices and/or volatile memory devices. The volatile memory devices (e.g., memory device 140) can be, but are not limited to, random access memory (RAM), such as dynamic random access memory (DRAM) and synchronous dynamic random access memory (SDRAM).

Some examples of non-volatile memory devices (e.g., memory device 130) include a negative-and (NAND) type flash memory and write-in-place memory, such as a three-dimensional cross-point (“3D cross-point”) memory device, which is a cross-point array of non-volatile memory cells. A cross-point array of non-volatile memory cells can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory devices 130 can include one or more arrays of memory cells. One type of memory cell, for example, single level memory cells (SLC) can store one bit per memory cell. Other types of memory cells, such as multi-level memory cells (MLCs), triple level memory cells (TLCs), quad-level memory cells (QLCs), and penta-level memory cells (PLCs) can store multiple bits per memory cell. In some embodiments, each of the memory devices 130 can include one or more arrays of memory cells such as SLCs, MLCs, TLCs, QLCs, PLCs or any combination of such. In some embodiments, a particular memory device can include an SLC portion, and an MLC portion, a TLC portion, a QLC portion, or a PLC portion of memory cells. The memory cells of the memory devices 130 can be grouped as pages that can refer to a logical unit of the memory device used to store data. With some types of memory (e.g., NAND), pages can be grouped to form blocks.

Although non-volatile memory components such as a 3D cross-point array of non-volatile memory cells and NAND type flash memory (e.g., 2D NAND, 3D NAND) are described, the memory device 130 can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), negative-or (NOR) flash memory, or electrically erasable programmable read-only memory (EEPROM).

A memory sub-system controller 115 (or controller 115 for simplicity) can communicate with the memory devices 130 to perform operations such as reading data, writing data, or erasing data at the memory devices 130 and other such operations. The memory sub-system controller 115 can include hardware such as one or more integrated circuits and/or discrete components, a buffer memory, or a combination thereof. The hardware can include a digital circuitry with dedicated (i.e., hard-coded) logic to perform the operations described herein. The memory sub-system controller 115 can be a microcontroller, special purpose logic circuitry (e.g., a field programmable gate array (FPGA), an application specific integrated circuit (ASIC), etc.), or other suitable processor.

The memory sub-system controller 115 can include a processing device, which includes one or more processors (e.g., processor 117), configured to execute instructions stored in a local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

In some embodiments, the local memory 119 can include memory registers storing memory pointers, fetched data, etc. The local memory 119 can also include read-only memory (ROM) for storing micro-code. While the example memory sub-system 110 in FIG. 1A has been illustrated as including the memory sub-system controller 115, in another embodiment of the present disclosure, a memory sub-system 110 does not include a memory sub-system controller 115, and can instead rely upon external control (e.g., provided by an external host, or by a processor or controller separate from the memory sub-system).

In general, the memory sub-system controller 115 can receive commands or operations from the host system 120 and can convert the commands or operations into instructions or appropriate commands to achieve the desired access to the memory devices 130. The memory sub-system controller 115 can be responsible for other operations such as wear leveling operations, garbage collection operations, error detection and error-correcting code (ECC) operations, encryption operations, caching operations, and address translations between a logical address (e.g., a logical block address (LBA), namespace) and a physical address (e.g., physical block address) that are associated with the memory devices 130. The memory sub-system controller 115 can further include host interface circuitry to communicate with the host system 120 via the physical host interface. The host interface circuitry can convert the commands received from the host system into command instructions to access the memory devices 130 as well as convert responses associated with the memory devices 130 into information for the host system 120.

The memory sub-system 110 can also include additional circuitry or components that are not illustrated. In some embodiments, the memory sub-system 110 can include a cache or buffer (e.g., DRAM) and address circuitry (e.g., a row decoder and a column decoder) that can receive an address from the memory sub-system controller 115 and decode the address to access the memory devices 130.

In some embodiments, the memory devices 130 include local media controllers 135 that operate in conjunction with memory sub-system controller 115 to execute operations on one or more memory cells of the memory devices 130. An external controller (e.g., memory sub-system controller 115) can externally manage the memory device 130 (e.g., perform media management operations on the memory device 130). In some embodiments, memory sub-system 110 is a managed memory device, which is a raw memory device 130 having control logic (e.g., local controller 132) on the die and a controller (e.g., memory sub-system controller 115) for media management within the same memory device package. An example of a managed memory device is a managed NAND (MNAND) device.

The local media controller 135 can implement PPM with dynamic data path operation current budget management. In such an embodiment, PPM component 137 can be implemented using hardware or as firmware, stored on memory device 130, executed by the control logic (e.g., local media controller 135) to perform the operations related to performing a memory access operation during PPM as described herein. In some embodiments, the memory sub-system controller 115 includes at least a portion of PPM component 137. For example, the memory sub-system controller 115 can include a processor 117 (e.g., a processing device) configured to execute instructions stored in local memory 119 for performing the operations described herein.

To implement PPM with dynamic data path operation current budget management, local media controller 135 and/or PPM component 137 can initialize PPM. For example, the local media controller 135 and/or PPM component 137 can initialize PPM with respect to a PPM network of the memory sub-system 110 after power up of the memory sub-system 110. The PPM network can include multiple dies forming a token ring group. The token ring group is an ordered group of dies. The token ring group can include a primary die and a number of secondary dies. For example, the first die of the token ring group can be assigned to be the primary die. The primary die can be responsible for controlling the passing of a PPM token using a clock signal (ICLK).

The PPM network can further include a plurality of channels, where each channel of the plurality of channels includes a respective set of dies of the plurality of dies. For example, each channel can include a pair of dies of the plurality of dies. However, such an example should not be considered limiting.

Initializing PPM can include pre-reserving, to a channel of the plurality of channels, an amount of current budget associated with a data path operation (e.g., a single channel). More specifically, pre-reserving the amount of current budget to the channel can include allocating a pre-reserved amount of current budget to the channel. The data path operation can be an ICC4 operation. In some embodiments, the data path operation is a data burst. For example, the data burst can be a read burst. As another example, the data burst can be a write burst.

Local media controller 135 and/or PPM component 137 can further identify a data path operation with respect a die of a given channel. In some embodiments, the given channel is the channel having the pre-reserved amount of current budget. In some embodiments, the given channel is another channel without the pre-reserved amount of current budget.

Upon identifying the data path operation, local media controller 135 and/or PPM component 137 can determine whether the given channel is ready for the die to handle the data path operation. More specifically, the determination can be made based on a set of status register bits. The set of status register bits can provide at least one value associated with a current budget ready status and a cache ready status.

In some embodiments, the set of status register bits includes a current budget ready status register bit and a cache ready status register bit (i.e., a ready/busy status register bit). The current budget ready status register bit can be an extended status register bit. The value of the current budget ready status register bit can indicate whether the data path operation current budget, assigned to the given channel, is ready for an incoming data path operation (e.g., data burst). The current budget ready status register bit is synchronized across all dies of the given channel. For example, if the value of the current budget ready status register bit is a reset value (e.g., “0”), this indicates that there is insufficient available data path operation current budget assigned to the given channel to handle a data path operation (e.g., data burst). If the value of the current budget ready status register bit is a set value (e.g., “1”), this indicates that there is sufficient available data path operation current budget assigned to the given channel to handle a data path operation.

The value of the cache ready status register bit can indicate whether an internal cache is ready for handling a data path operation (e.g., data burst). For example, the cache ready status register bit can correspond to pin SR[6]. The value of the cache ready status register bit can correspond to the value of the ready/busy signal (RB #). More specifically, a first value of the cache ready status register bit can indicate “busy” (e.g., “0”), while a second value of the cache ready status register bit can indicate “ready”) (e.g., “1”). Accordingly, the cache ready status register bit can return the second value when the internal cache is available to receive new data.

Determining whether the given channel is ready can include performing status register polling to check the value of the current budget ready status register bit and the value of the cache ready status register bit for the corresponding die, and determine whether the values of the current budget ready status register bit and the cache ready status register bit are both ready values (e.g., “1”). The given channel is determined to be ready in response to determining that the values of the current budget ready status register bit and the cache ready status register bit are both ready values.

In some embodiments, the set of status register bits includes a modified cache ready status register bit. The memory device can internally provide the modified cache ready status register bit based on the cache ready status and the current budget ready status. More specifically, the memory device can implement AND logic, such that the modified cache ready status register bit will provide a ready value when both the cache ready status and the budget ready status are both ready (e.g., the modified cache ready status register bit has a value of “1”). Determining whether the given channel is ready can include performing status register polling to check the value corresponding to the modified cache ready status register bit for the die, and determine whether the value corresponding to the modified cache ready status register bit is a ready value (e.g., “1”). The given channel is determined to be ready in response to determining that the values of the current budget ready status register bit and the cache ready status register bit are both ready values.

If the given channel is not ready, then local media controller 135 and/or PPM component 137 can continue to determine whether the given channel is ready (e.g., by continuing to perform status register polling). Otherwise, if the given channel is ready, then local media controller 135 and/or PPM component 137 can cause the data path operation to be handled. Causing the data path operation to be handled can include causing the current budget allocated to the given channel to be consumed by the die.

Local media controller 135 and/or PPM component 137 can then cause PPM data to be communicated to the other dies. More specifically, control logic can cause the PPM data to be communicated to the other dies via their respective PPM components. The PPM data can include current consumption data related to the amount of current consumed during execution of the data path operation. After communicating the data to the other dies (i.e., the PPM data or the auxiliary data), the PPM component 137 can cause the PPM token to be passed to the next die of the token ring group. The process can repeat upon receiving the PPM token during the next PPM cycle. Further details regarding implementing PPM with dynamic data path operation current budget management will now be described below with reference to FIGS. 1B-11.

FIG. 1B is a simplified block diagram of a first apparatus, in the form of a memory device 130, in communication with a second apparatus, in the form of a memory sub-system controller 115 of a memory sub-system (e.g., memory sub-system 110 of FIG. 1A), according to an embodiment. Some examples of electronic systems include personal computers, personal digital assistants (PDAs), digital cameras, digital media players, digital recorders, games, appliances, vehicles, wireless devices, mobile telephones and the like. The memory sub-system controller 115 (e.g., a controller external to the memory device 130), may be a memory controller or other external host device.

Memory device 130 includes an array of memory cells 104 logically arranged in rows and columns. Memory cells of a logical row are typically connected to the same access line (e.g., a wordline) while memory cells of a logical column are typically selectively connected to the same data line (e.g., a bitline). A single access line may be associated with more than one logical row of memory cells and a single data line may be associated with more than one logical column. Memory cells (not shown in FIG. 1B) of at least a portion of array of memory cells 104 are capable of being programmed to one of at least two target data states.

Row decode circuitry 108 and column decode circuitry 112 are provided to decode address signals. Address signals are received and decoded to access the array of memory cells 104. Memory device 130 also includes input/output (I/O) control circuitry 160 to manage input of commands, addresses and data to the memory device 130 as well as output of data and status information from the memory device 130. An address register 114 is in communication with I/O control circuitry 160 and row decode circuitry 108 and column decode circuitry 112 to latch the address signals prior to decoding. A command register 124 is in communication with I/O control circuitry 160 and local media controller 135 to latch incoming commands.

A controller (e.g., the local media controller 135 internal to the memory device 130) controls access to the array of memory cells 104 in response to the commands and generates status information for the external memory sub-system controller 115, i.e., the local media controller 135 is configured to perform access operations (e.g., read operations, programming operations and/or erase operations) on the array of memory cells 104. The local media controller 135 is in communication with row decode circuitry 108 and column decode circuitry 112 to control the row decode circuitry 108 and column decode circuitry 112 in response to the addresses. In one embodiment, local media controller 135 includes the PPM component 137, which can implement the defect detection described herein during an erase operation on memory device 130.

The local media controller 135 is also in communication with a cache register 118. Cache register 118 latches data, either incoming or outgoing, as directed by the local media controller 135 to temporarily store data while the array of memory cells 104 is busy writing or reading, respectively, other data. During a program operation (e.g., write operation), data may be passed from the cache register 118 to the data register 170 for transfer to the array of memory cells 104; then new data may be latched in the cache register 118 from the I/O control circuitry 160. During a read operation, data may be passed from the cache register 118 to the I/O control circuitry 160 for output to the memory sub-system controller 115; then new data may be passed from the data register 170 to the cache register 118. The cache register 118 and/or the data register 170 may form (e.g., may form a portion of) a page buffer of the memory device 130. A page buffer may further include sensing devices (not shown in FIG. 1B) to sense a data state of a memory cell of the array of memory cells 204, e.g., by sensing a state of a data line connected to that memory cell. A status register 122 may be in communication with I/O control circuitry 160 and the local memory controller 135 to latch the status information for output to the memory sub-system controller 115.

Memory device 130 receives control signals at the memory sub-system controller 115 from the local media controller 135 over a control link 132. For example, the control signals can include a chip enable signal CE #, a command latch enable signal CLE, an address latch enable signal ALE, a write enable signal WE #, a read enable signal RE #, and a write protect signal WP #. Additional or alternative control signals (not shown) may be further received over control link 132 depending upon the nature of the memory device 130. In one embodiment, memory device 130 receives command signals (which represent commands), address signals (which represent addresses), and data signals (which represent data) from the memory sub-system controller 115 over a multiplexed input/output (I/O) bus 136 and outputs data to the memory sub-system controller 115 over I/O bus 136.

For example, the commands may be received over input/output (I/O) pins [7:0] of I/O bus 136 at I/O control circuitry 160 and may then be written into command register 124. The addresses may be received over input/output (I/O) pins [7:0] of I/O bus 136 at I/O control circuitry 160 and may then be written into address register 114. The data may be received over input/output (I/O) pins [7:0] for an 8-bit device or input/output (I/O) pins [15:0] for a 16-bit device at I/O control circuitry 160 and then may be written into cache register 118. The data may be subsequently written into data register 170 for programming the array of memory cells 104.

In an embodiment, cache register 118 may be omitted, and the data may be written directly into data register 170. Data may also be output over input/output (I/O) pins [7:0] for an 8-bit device or input/output (I/O) pins [15:0] for a 16-bit device. Although reference may be made to I/O pins, they may include any conductive node providing for electrical connection to the memory device 130 by an external device (e.g., the memory sub-system controller 115), such as conductive pads or conductive bumps as are commonly used.

It will be appreciated by those skilled in the art that additional circuitry and signals can be provided, and that the memory device 130 of FIGS. 1A-1B has been simplified. It should be recognized that the functionality of the various block components described with reference to FIGS. 1A-1B may not necessarily be segregated to distinct components or component portions of an integrated circuit device. For example, a single component or component portion of an integrated circuit device could be adapted to perform the functionality of more than one block component of FIGS. 1A-1B. Alternatively, one or more components or component portions of an integrated circuit device could be combined to perform the functionality of a single block component of FIGS. 1A-1B. Additionally, while specific I/O pins are described in accordance with popular conventions for receipt and output of the various signals, it is noted that other combinations or numbers of I/O pins (or other I/O node structures) may be used in the various embodiments.

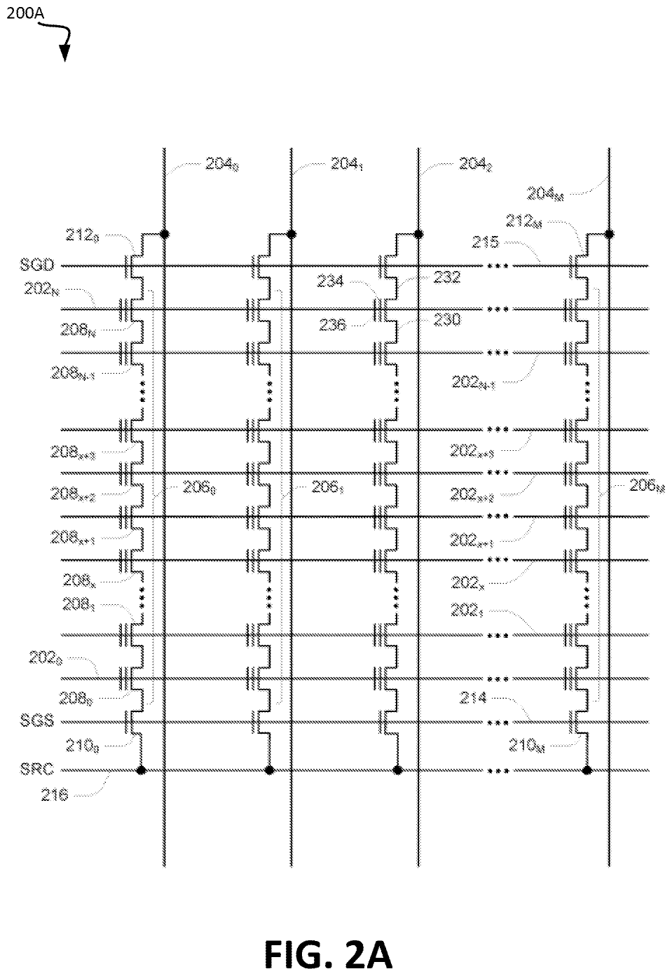

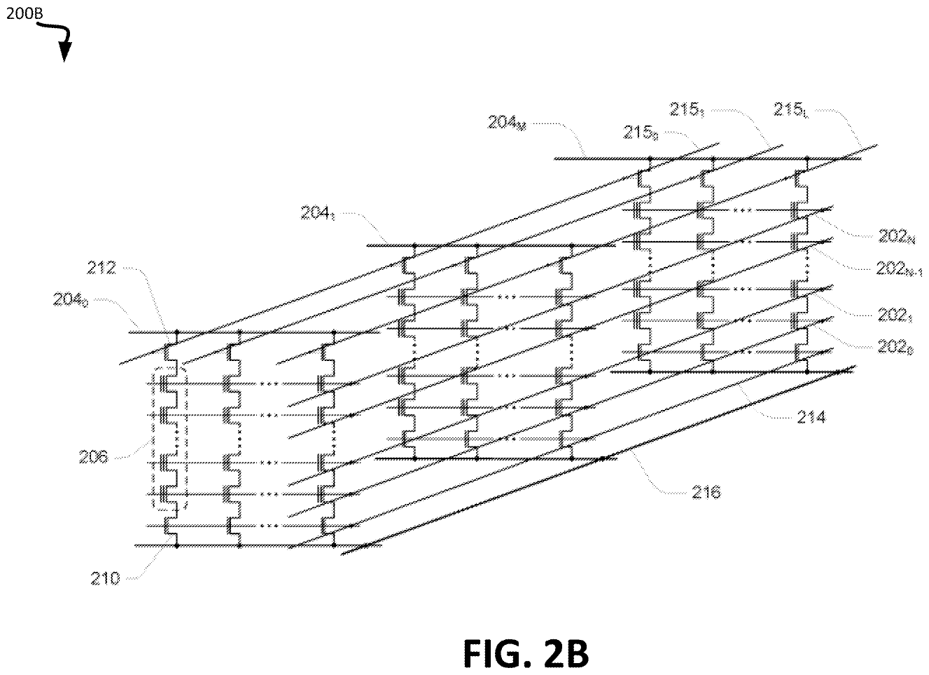

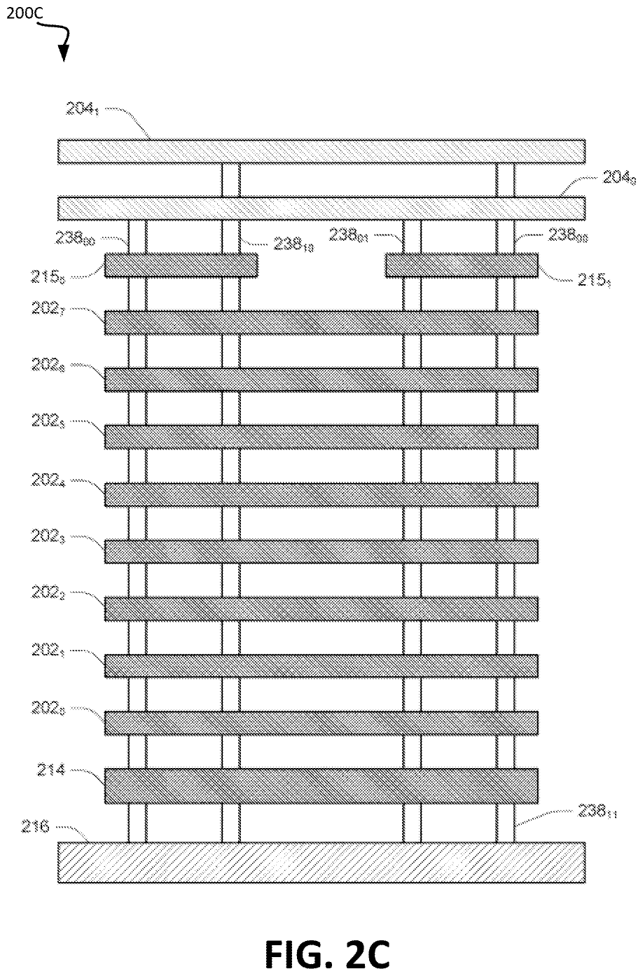

FIGS. 2A-2C are diagrams of portions of an example array of memory cells included in a memory device, in accordance with some embodiments of the present disclosure. For example, FIG. 2A is a schematic of a portion of an array of memory cells 200A as could be used in a memory device (e.g., as a portion of array of memory cells 104). Memory array 200A includes access lines, such as wordlines 202o to 202N, and a data line, such as bitline 204. The wordlines 202 may be connected to global access lines (e.g., global wordlines), not shown in FIG. 2A, in a many-to-one relationship. For some embodiments, memory array 200A may be formed over a semiconductor that, for example, may be conductively doped to have a conductivity type, such as a p-type conductivity, e.g., to form a p-well, or an n-type conductivity, e.g., to form an n-well.

Memory array 200A can be arranged in rows each corresponding to a respective wordline 202 and columns each corresponding to a respective bitline 204. Rows of memory cells 208 can be divided into one or more groups of physical pages of memory cells 208, and physical pages of memory cells 208 can include every other memory cell 208 commonly connected to a given wordline 202. For example, memory cells 208 commonly connected to wordline 202N and selectively connected to even bitlines 204 (e.g., bitlines 204o, 2042, 2044, etc.) may be one physical page of memory cells 208 (e.g., even memory cells) while memory cells 208 commonly connected to wordline 202N and selectively connected to odd bitlines 204 (e.g., bitlines 2041, 2043, 2045, etc.) may be another physical page of memory cells 208 (e.g., odd memory cells). Although bitlines 2043-2045 are not explicitly depicted in FIG. 2A, it is apparent from the figure that the bitlines 204 of the array of memory cells 200A may be numbered consecutively from bitline 204o to bitline 204M. Other groupings of memory cells 208 commonly connected to a given wordline 202 may also define a physical page of memory cells 208. For certain memory devices, all memory cells commonly connected to a given wordline might be deemed a physical page of memory cells. The portion of a physical page of memory cells (which, in some embodiments, could still be the entire row) that is read during a single read operation or programmed during a single programming operation (e.g., an upper or lower page of memory cells) might be deemed a logical page of memory cells. A block of memory cells may include those memory cells that are configured to be erased together, such as all memory cells connected to wordlines 2020-202N (e.g., all strings 206 sharing common wordlines 202). Unless expressly distinguished, a reference to a page of memory cells herein refers to the memory cells of a logical page of memory cells.

Each column can include a string of series-connected memory cells (e.g., non-volatile memory cells), such as one of strings 206o to 206M. Each string 206 can be connected (e.g., selectively connected) to a source line 216 (SRC) and can include memory cells 208o to 208N. The memory cells 208 of each string 206 can be connected in series between a select gate 210, such as one of the select gates 210o to 210m, and a select gate 212, such as one of the select gates 212o to 212m. In some embodiments, the select gates 210o to 210m are source-side select gates (SGS) and the select gates 212o to 212m are drain-side select gates. Select gates 210o to 210m can be connected to a select line 214 (e.g., source-side select line) and select gates 212o to 212m can be connected to a select line 215 (e.g., drain-side select line). The select gates 210 and 212 might represent a plurality of select gates connected in series, with each select gate in series configured to receive a same or independent control signal. A source of each select gate 210 can be connected to SRC 216, and a drain of each select gate 210 can be connected to a memory cell 2080 of the corresponding string 206. Therefore, each select gate 210 can be configured to selectively connect a corresponding string 206 to SRC 216. A control gate of each select gate 210 can be connected to select line 214. The drain of each select gate 212 can be connected to the bitline 204 for the corresponding string 206. The source of each select gate 212 can be connected to a memory cell 208N of the corresponding string 206. Therefore, each select gate 212 might be configured to selectively connect a corresponding string 206 to the bitline 204. A control gate of each select gate 212 can be connected to select line 215.

In some embodiments, and as will be described in further detail below with reference to FIG. 2B, the memory array in FIG. 2A is a three-dimensional memory array, in which the strings 206 extend substantially perpendicular to a plane containing SRC 216 and to a plane containing a plurality of bitlines 204 that can be substantially parallel to the plane containing SRC 216.

FIG. 2B is another schematic of a portion of an array of memory cells 200B (e.g., a portion of the array of memory cells 104) arranged in a three-dimensional memory array structure. The three-dimensional memory array 200B may incorporate vertical structures which may include semiconductor pillars where a portion of a pillar may act as a channel region of the memory cells of strings 206. The strings 206 may be each selectively connected to a bit line 2040-204m by a select gate 212 and to the SRC 216 by a select gate 210. Multiple strings 206 can be selectively connected to the same bitline 204. Subsets of strings 206 can be connected to their respective bitlines 204 by biasing the select lines 2150-215L to selectively activate particular select gates 212 each between a string 206 and a bitline 204. The select gates 210 can be activated by biasing the select line 214. Each wordline 202 may be connected to multiple rows of memory cells of the memory array 200B. Rows of memory cells that are commonly connected to each other by a particular wordline 202 may collectively be referred to as tiers.

FIG. 2C is a diagram of a portion of an array of memory cells 200C (e.g., a portion of the array of memory cells 104). Channel regions (e.g., semiconductor pillars) 23800 and 23801 represent the channel regions of different strings of series-connected memory cells (e.g., strings 206 of FIGS. 2A-2B) selectively connected to the bitline 2040. Similarly, channel regions 23810 and 238ii represent the channel regions of different strings of series-connected memory cells (e.g., NAND strings 206 of FIGS. 2A-2B) selectively connected to the bitline 2041. A memory cell (not depicted in FIG. 2C) may be formed at each intersection of a wordline 202 and a channel region 238, and the memory cells corresponding to a single channel region 238 may collectively form a string of series-connected memory cells (e.g., a string 206 of FIGS. 2A-2B). Additional features might be common in such structures, such as dummy wordlines, segmented channel regions with interposed conductive regions, etc.

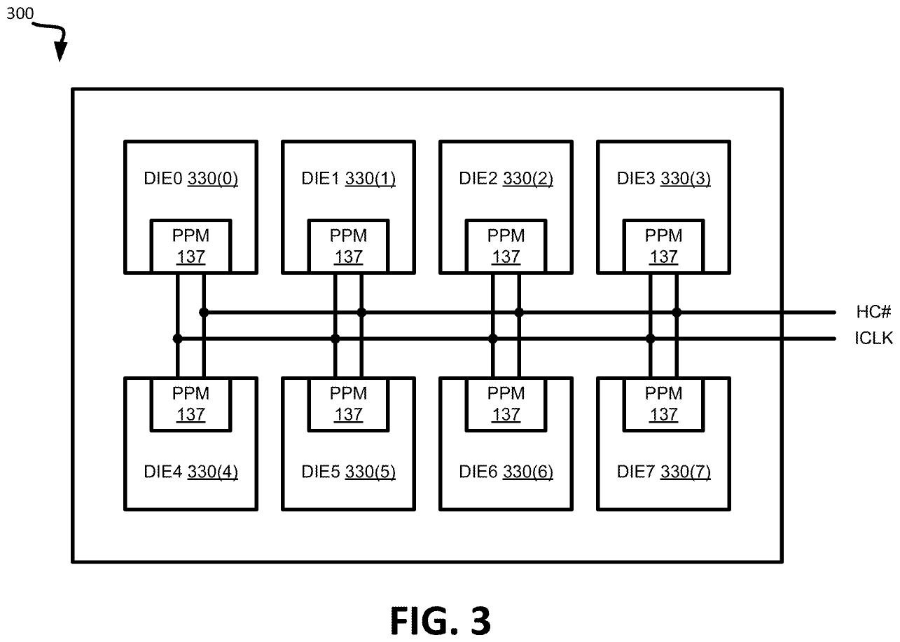

FIG. 3 is a block diagram illustrating a multi-die package 300 with multiple memory dies in a memory sub-system, in accordance with some embodiments of the present disclosure. As illustrated, multi-die package 300 includes memory dies 330(0)-330(7). In other embodiments, however, multi-die package 300 can include some other number of memory dies, such as additional or fewer memory dies. In one embodiment, memory dies 330(0)-330(7) share a clock signal ICLK which is received via a clock signal line. Memory dies 330(0)-330(7) can be selectively enabled in response to a chip enable signal (e.g., via a control link), and can communicate over a separate I/O bus. In addition, a peak current magnitude indicator signal HC # is commonly shared between the memory dies 330(0)-330(7). The peak current magnitude indicator signal HC #can be normally pulled to a particular state (e.g., pulled high). In one embodiment, each of memory dies 330(0)-330(7) includes an instance of PPM component 137, which receives both the clock signal ICLK and the peak current magnitude indicator signal HC #.

In one embodiment, a token-based protocol is used where a token cycles through each of the memory dies 330(0)-330(7) for determining and broadcasting expected peak current magnitude, even though some of the memory dies 330(0)-330(7) might be disabled in response to their respective chip enable signal. The period of time during which a given PPM component 137 holds this token (e.g., a certain number of cycles of clock signal ICLK) can be referred to herein as a power management cycle of the associated memory die. At the end of the power management cycle, the token is passed to another memory die. Eventually the token is received again by the same PPM component 137, which signals the beginning of the power management cycle for the associated memory die. In one embodiment, the encoded value for the lowest expected peak current magnitude is configured such that each of its digits correspond to the normal logic level of the peak current magnitude indicator signal HC # where the disabled dies do not transition the peak current magnitude indicator signal HC #. In other embodiments, however, the memory dies can be configured, when otherwise disabled in response to their respective chip enable signal, to drive transitions of the peak current magnitude indicator signal HC # to indicate the encoded value for the lowest expected peak current magnitude upon being designated. When a given PPM component 137 holds the token, it can determine the peak current magnitude for the respective one of memory die 330(0)-330(7), which can be attributable to one or more processing threads on that memory die, and broadcast an indication of the same via the peak current magnitude indicator signal HC #. During a given power management cycle, the PPM component 137 can arbitrate among the multiple processing threads on the respective memory die using one of a number of different arbitration schemes in order to allocate that peak current to enable concurrent memory access operations.

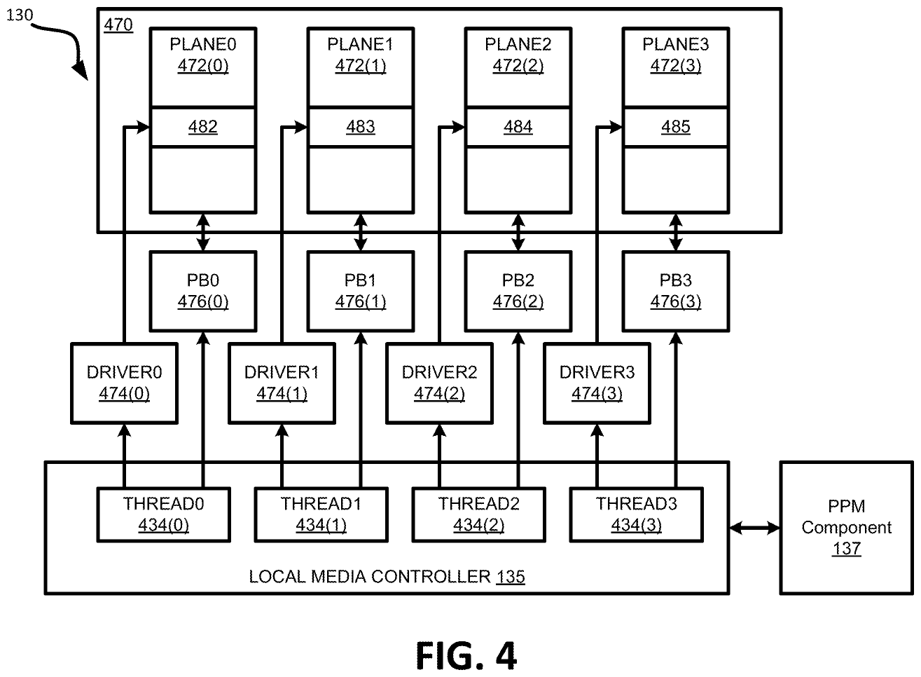

FIG. 4 is a block diagram illustrating a multi-plane memory device 130 configured for independent parallel plane access, in accordance with some embodiments of the present disclosure. The memory planes 472(0)-472(3) can each be divided into blocks of data, with a different relative block of data from two or more of the memory planes 472(0)-472(3) concurrently accessible during memory access operations. For example, during memory access operations, two or more of data block 482 of the memory plane 472(0), data block 483 of the memory plane 472(1), data block 484 of the memory plane 472(2), and data block 485 of the memory plane 4372(3) can each be accessed concurrently.

The memory device 130 includes a memory array 470 divided into memory planes 472(0)-472(3) that each includes a respective number of memory cells. The multi-plane memory device 130 can further include local media controller 135, including a power control circuit and access control circuit for concurrently performing memory access operations for different memory planes 472(0)-472(3). The memory cells can be non-volatile memory cells, such as NAND flash cells, or can generally be any type of memory cells.

The memory planes 472(0)-472(3) can each be divided into blocks of data, with a different relative block of data from each of the memory planes 472(0)-472(3) concurrently accessible during memory access operations. For example, during memory access operations, data block 482 of the memory plane 472(0), data block 483 of the memory plane 472(1), data block 484 of the memory plane 472(2), and data block 485 of the memory plane 472(3) can each be accessed concurrently.

Each of the memory planes 472(0)-372(3) can be coupled to a respective page buffer 476(0)-476(3). Each page buffer 476(0)-376(3) can be configured to provide data to or receive data from the respective memory plane 472(0)-472(3). The page buffers 476(0)-476(3) can be controlled by local media controller 135. Data received from the respective memory plane 472(0)-472(3) can be latched at the page buffers 476(0)-476(3), respectively, and retrieved by local media controller 135, and provided to the memory sub-system controller 115 via the interface.

Each of the memory planes 472(0)-472(3) can be further coupled to a respective access driver circuit 474(0)-474(3), such as an access line driver circuit. The driver circuits 474(0)-474(3) can be configured to condition a page of a respective block of an associated memory plane 472(0)-472(3) for a memory access operation, such as programming data (i.e., writing data), reading data, or erasing data. Each of the driver circuits 474(0)-474(3) can be coupled to a respective global access lines associated with a respective memory plane 472(0)-472(3). Each of the global access lines can be selectively coupled to respective local access lines within a block of a plane during a memory access operation associated with a page within the block. The driver circuits 474(0)-474(3) can be controlled based on signals from local media controller 135. Each of the driver circuits 474(0)-474(3) can include or be coupled to a respective power circuit, and can provide voltages to respective access lines based on voltages provided by the respective power circuit. The voltages provided by the power circuits can be based on signals received from local media controller 135.

The local media controller 135 can control the driver circuits 474(0)-474(3) and page buffers 476(0)-476(3) to concurrently perform memory access operations associated with each of a group of memory command and address pairs (e.g., received from memory sub-system controller 115). For example, local media controller 135 can control the driver circuits 474(0)-474(3) and page buffer 476(0)-476(3) to perform the concurrent memory access operations. Local media controller 135 can include a power control circuit that serially configures two or more of the driver circuits 474(0)-474(3) for the concurrent memory access operations, and an access control circuit configured to control two or more of the page buffers 476(0)-476(3) to sense and latch data from the respective memory planes 472(0)-472(3), or program data to the respective memory planes 472(0)-472(3) to perform the concurrent memory access operations.

In operation, local media controller 135 can receive a group of memory command and address pairs via the bus, with each pair arriving in parallel or serially. In some examples, the group of memory command and address pairs can each be associated with different respective memory planes 472(0)-472(3) of the memory array 470. The local media controller 135 can be configured to perform concurrent memory access operations (e.g., read operations or program operations) for the different memory planes 472(0)-472(3) of the memory array 470 responsive to the group of memory command and address pairs. For example, the power control circuit of local media controller 135 can serially configure, for the concurrent memory access operations based on respective page type (e.g., UP, TP, LP, XP, SLC/MLC/TLC/QLC page), the driver circuits 474(0)-474(3) for two or more memory planes 472(0)-472(3) associated with the group of memory command and address pairs. After the access line driver circuits 474(0)-474(3) have been configured, the access control circuit of local media controller 135 can concurrently control the page buffers 476(0)-476(3) to access the respective pages of each of the two or more memory planes 472(0)-472(3) associated with the group of memory command and address pairs, such as retrieving data or writing data, during the concurrent memory access operations. For example, the access control circuit can concurrently (e.g., in parallel and/or contemporaneously) control the page buffers 476(0)-476(3) to charge/discharge bitlines, sense data from the two or more memory planes 472(0)-472(3), and/or latch the data.

Based on the signals received from local media controller 135, the driver circuits 474(0)-474(3) that are coupled to the memory planes 472(0)-472(3) associated with the group of memory command and address command pairs can select blocks of memory or memory cells from the associated memory plane 472(0)-472(3), for memory operations, such as read, program, and/or erase operations. The driver circuits 474(0)-474(3) can drive different respective global access lines associated with a respective memory plane 472(0)-472(3). As an example, the driver circuit 474(0) can drive a first voltage on a first global access line associated with the memory plane 472(0), the driver circuit 474(1) can drive a second voltage on a third global access line associated with the memory plane 472(1), the driver circuit 474(2) can drive a third voltage on a seventh global access line associated with the memory plane 472(2), etc., and other voltages can be driven on each of the remaining global access lines. In some examples, pass voltages can be provided on all access lines except an access line associated with a page of a memory plane 472(0)-472(3) to be accessed. The local media controller 135, the driver circuits 474(0)-474(3) can allow different respective pages, and the page buffers 476(0)-476(3) within different respective blocks of memory cells, to be accessed concurrently. For example, a first page of a first block of a first memory plane can be accessed concurrently with a second page of a second block of a second memory plane, regardless of page type.

The page buffers 476(0)-476(3) can provide data to or receive data from the local media controller 135 during the memory access operations responsive to signals from the local media controller 135 and the respective memory planes 472(0)-472(3). The local media controller 135 can provide the received data to memory sub-system controller 115.

It will be appreciated that the memory device 130 can include more or less than four memory planes, driver circuits, and page buffers. It will also be appreciated that the respective global access lines can include 8, 16, 32, 64, 128, etc., global access lines. The local media controller 135 and the driver circuits 474(0)-474(3) can concurrently access different respective pages within different respective blocks of different memory planes when the different respective pages are of a different page type. For example, local media controller 135 can include a number of different processing threads, such as processing threads 434(0)-434(3). Each of processing threads 434(0)-434(3) can be associated with a respective one of memory planes 472(0)-472(3), or a respective group of memory planes, and can manage operations performed on the respective plane or group of planes. For example, each of processing threads 434(0)-434(3) can provide control signals to the respective one of driver circuits 474(0)-474(3) and page buffers 476(0)-476(3) to perform those memory access operations concurrently (e.g., at least partially overlapping in time). Since the processing threads 434(0)-434(3) can perform the memory access operations, each of processing threads 434(0)-434(3) can have different current requirements at different points in time. PPM component 137 can determine the power budget needs of processing threads 434(0)-434(3) in a given power management cycle and identify one or more of processing threads 434(0)-434(3) using one of a number of power budget arbitration schemes described herein. The one or more processing threads 434(0)-434(3) can be determined based on an available power budget in the memory sub-system 110 during the power management cycles. For example, PPM component 137 can determine respective priorities of processing threads 434(0)-434(3), and allocate current to processing threads 434(0)-434(3) based on the respective priorities.

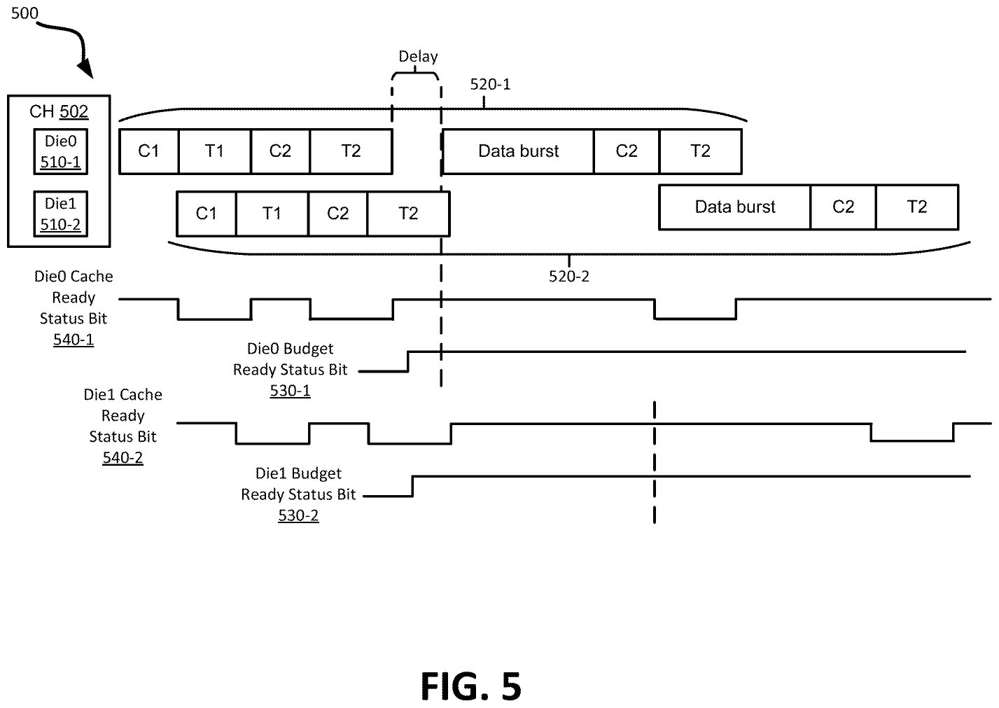

FIG. 5 illustrates a diagram 500 of an example implementation of PPM with dynamic data path operation current budget management, in accordance with some embodiments of the present disclosure. The diagram 500 shows a channel (CH) 502 including two memory dies (“dies”), Die0 510-1 and Die1 510-2. Each of the dies can correspond to a respective LUN. Although only one channel is shown, the system can include any number of channels.

In some embodiments, the cache operation is a cache read operation. Cache read operations can be implemented by an internal cache buffer to allow consecutive pages to be read-out without giving the next page address, which can reduce latency time. In some embodiments, the cache operation is a cache write operation. Cache write operations can be implemented by the internal cache buffer to allow consecutive page writes. In the illustrative example shown in FIG. 5, it is assumed that the cache operation is a cache read operation.

For example, Die0 510-1 is associated with command sequence 520-1. Command sequence 520-1 includes command block 1 (C1) and a command block 2 (C2). A first latency (T1) follows C1 and a second latency (T2) follows C2. Command sequence 520-1 includes a data path operation followed by C2. In this example, the data path operation is a data burst. T2 follows C2. Moreover, Die1 510-2 is associated with command sequence 520-2. Command sequence 520-2 is similar to command sequence 520-1.

C1 and C2 can each include one or more commands. In some embodiments, the command sequence 520-1 can be a cache read operation sequence. For example, C1 can include an initial cache read command (e.g., 00h command) after which an address (i.e., column and row address) is provided for the initial page selection, and an address confirmation command (e.g., a 30h command). After C1, the cache read operation begins after T1. More specifically, T1 is the time for transferring data from the memory array to the buffer. C2 can include a sequential cache read command (e.g., 31h command or 3Fh command) to confirm the next page to be read-out during the cache read operation. Thus, after T2, data can be read out sequentially from a first address without providing the next page address as input. More specifically, T2 is the busy time for the cache read (e.g., tRCBSY).

Diagram 500 further shows values of the Die0 budget ready status register bit 530-1, values of the Die0 cache ready status register bit 540-1, values of the Die1 Budget ready status register bit 530-2, and values of the Die1 cache ready status register bit 540-2. The values of the budget ready status register bits 530-1 and 530-2 are synchronized as Die0 and Die1 are within the same channel. The values of the cache ready status register bits 540-1 and 540-2 are based on when there is an active command or a time delay. For example, the cache ready status register bits 540-1 and 540-2 can have a value of “1” during a command (e.g., C1, C2, data burst), and a value of “0” during T1 and T2.

In this example, it is assumed that an amount of data path operation current budget has been pre-reserved for CH 502. At some delay after T2 of command sequence 520-1, the incoming data burst of command sequence 520-1 is received. The values of the Die0 Budget ready status register bit 530-1 and the Die0 cache ready status register bit 540-1 are each “1”, which indicates to the ASIC that Die0 510-1 is ready to handle the data burst. Similarly, after C2 of command sequence 530-1, the incoming data burst of command sequence 520-2 is received. The values of the Die1 Budget ready status register bit 530-2 and the Die1 cache ready status register bit 540-2 are each “1”, which indicates to the ASIC that Die1 510-2 is ready to handle the data burst. Accordingly, since data path operation current budget has been preserved for CH 502, the data bursts of the command sequences 520-1 and 520-2 can be handled immediately.

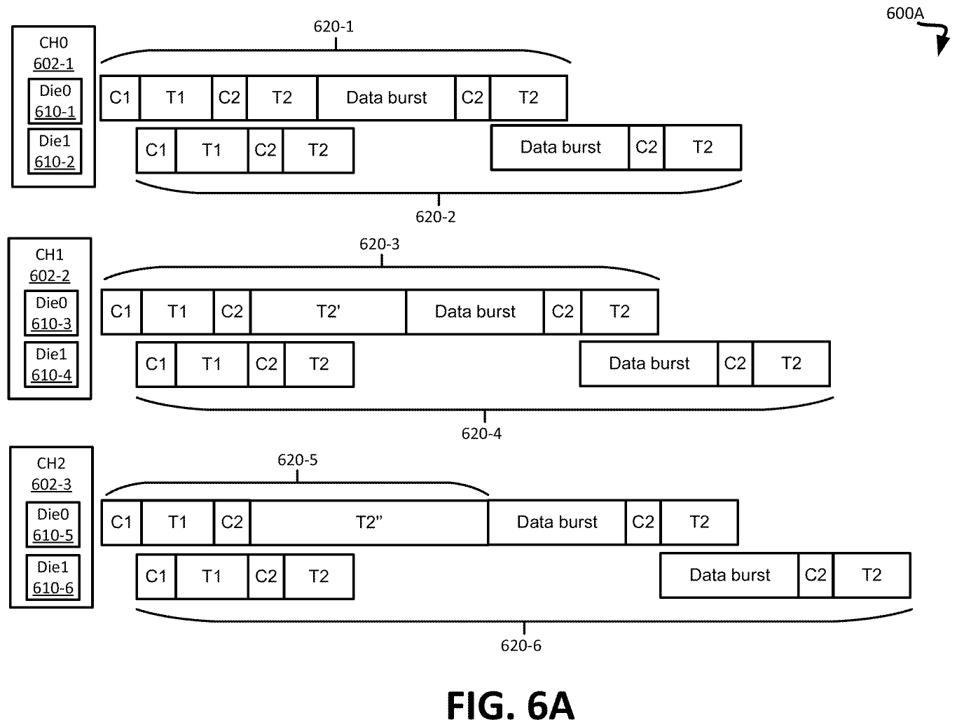

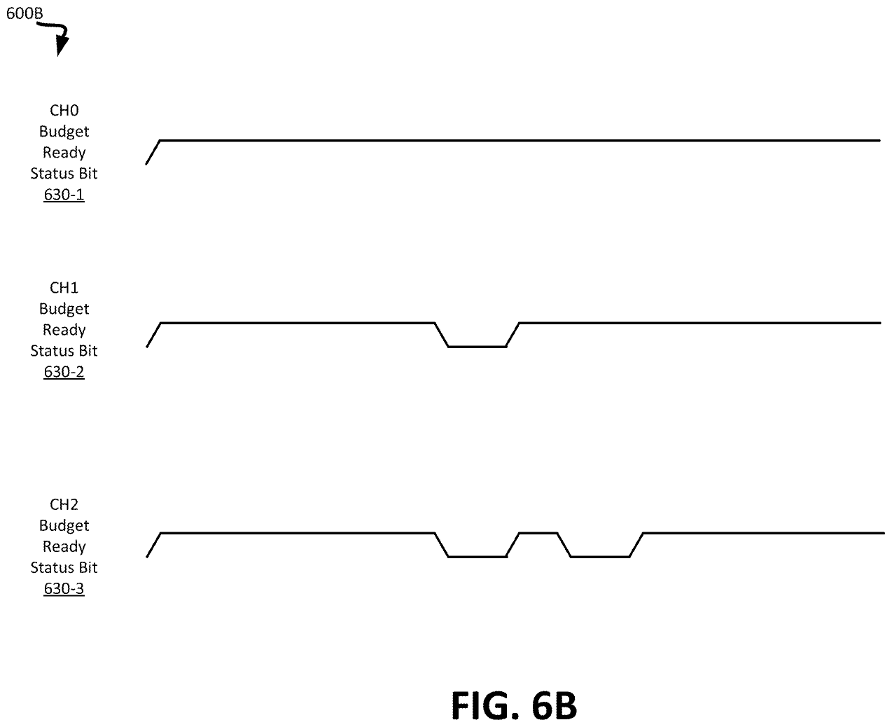

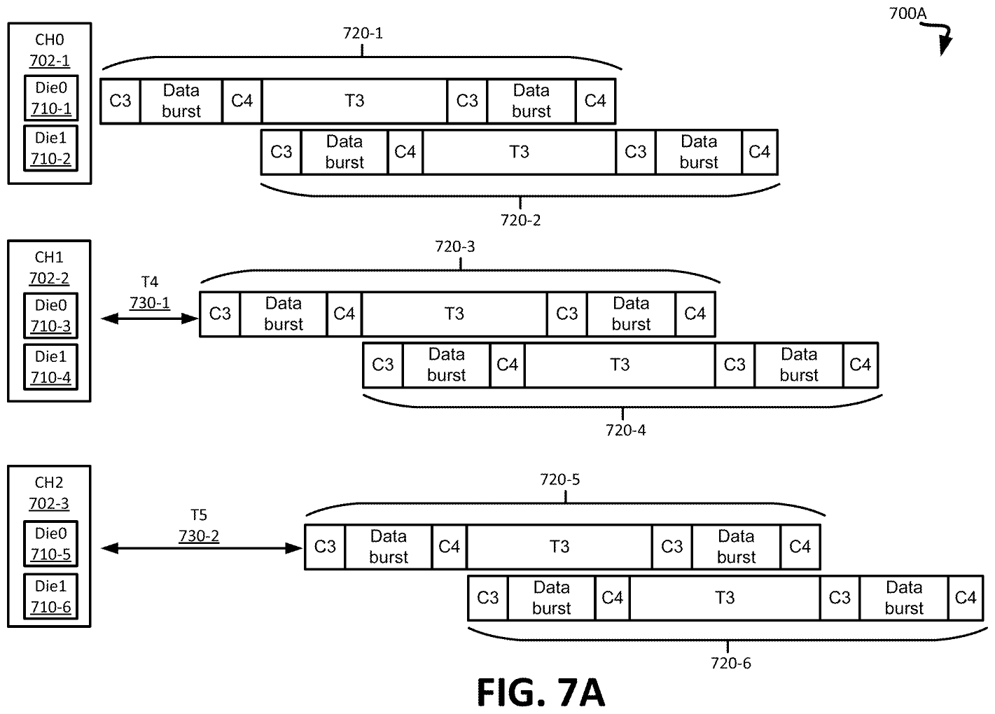

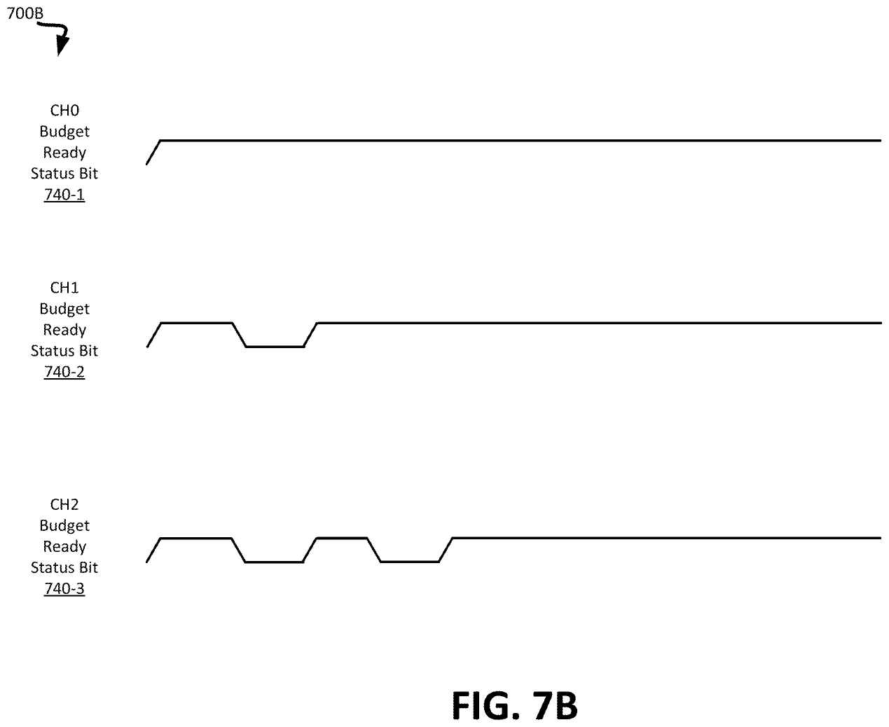

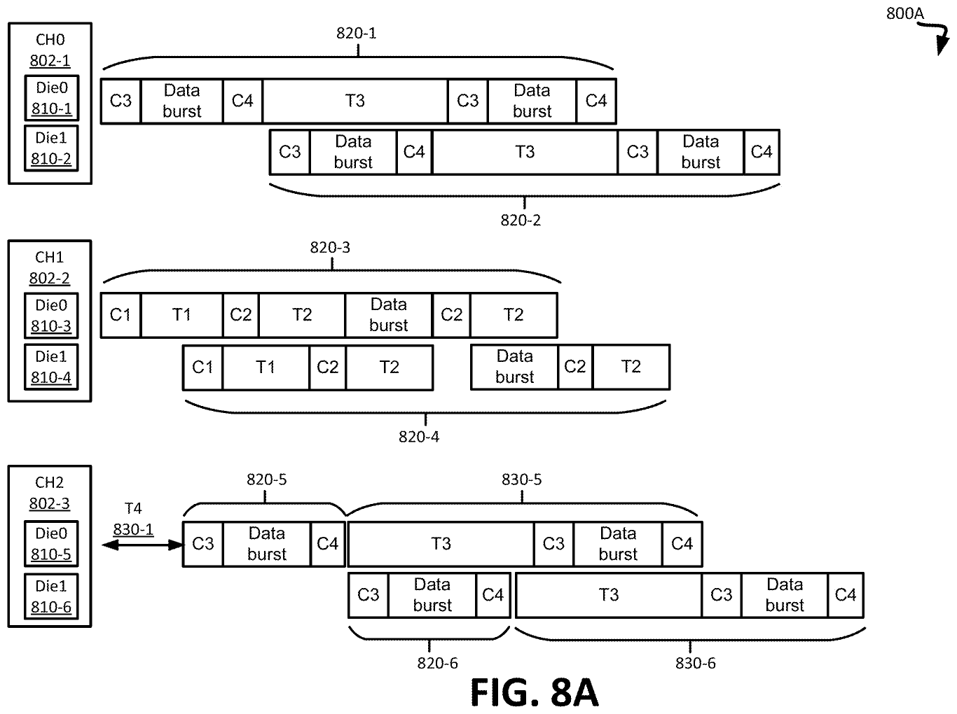

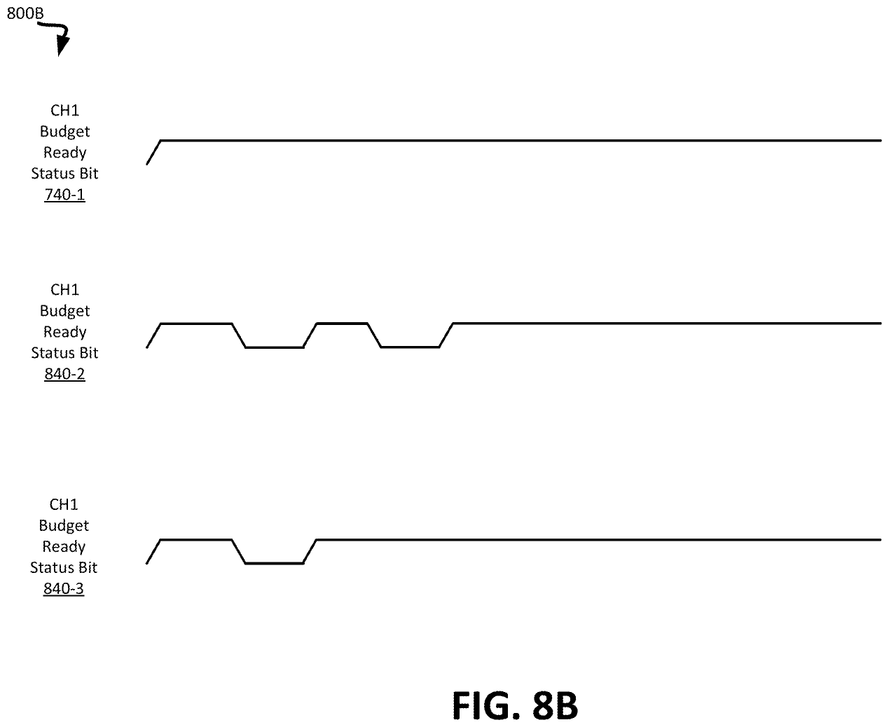

Another example implementation of PPM with cache read operation current management will be described below with reference to FIGS. 6A-6B. An example implementation of PPM with cache write operation current management will be described below with reference to FIGS. 7A-7B. An example implementation of PPM with mixed load dynamic data path operation current budget management (e.g., a combination of cache read operations and cache write operations) will be described below with reference to FIGS. 8A-8B.

FIGS. 6A-6B are diagrams illustrating an example implementation of PPM with cache read operation current management, in accordance with some embodiments of the present disclosure. For example, FIG. 6A is a diagram 600A showing multiple channels (CH) including CH0 602-1, CH1 602-2 and CH2 602-3. Each of the channels is shown including two dies. For example, CH0 602-1 includes Die0 610-1 and Die1 610-2, CH1 602-2 includes Die0 610-3 and Die1 610-4, and CH2 602-3 includes Die0 610-5 and Die1 610-6. Each of the dies can correspond to a respective LUN. Although three channels and six dies are shown, the system can include any number of channels and/or dies.

In this illustrative example, with respect to CH0 602-1, Die0 610-1 is associated with command sequence 620-1. Command sequence 620-1 includes C1 and C2, as described above with reference to FIG. 5. T1 follows C1 and T2 follows C2, as described above with reference to FIG. 5. Command sequence 620-1 includes a data path operation followed by C2, as described above with reference to FIG. 5. For example, the data path operation can be a data burst (e.g., read burst). T2 follows C2, as described above with reference to FIG. 5. Moreover, Die1 610-2 is associated with command sequence 620-2. Command sequence 620-2 is similar to command sequence 620-1.

With respect to CH0 602-1, in this example, it is assumed that an amount of data path operation current budget has been pre-reserved for CH 602-1. Because of this, as shown in FIG. 6B, the CH0 budget ready status register bit 630-1 is always ready (e.g., always “1”). Thus, at some delay after T2 of command sequence 620-1, the incoming data burst of command sequence 620-1 is received and handled immediately by Die0 610-1 (it is assumed that the cache ready status register bit of Die0 610-1 is ready (e.g., “1”)). This is similar for the incoming data burst of command sequence 620-2, which is received and handled immediate by Die1 610-2.

With respect to CH1 602-2 and CH2 602-3, as shown in FIG. 6B, the values of the CH1 budget ready status register bit 630-2 and the CH2 budget ready status register bit 630-3 each go from ready to busy (e.g., from “1” to “0”) upon the initiation of the data burst handled by Die0 610-1. This is because CH1 602-3 and CH2 602-3 have to wait for the PPM component to reserve a second amount of data path operation current budget. As shown in FIG. 6B, once the PPM component has reserved the second amount of data path operation current budget, the values of the CH1 budget ready status register bit 630-2 and the CH2 budget ready status register bit 630-3 each go from busy to ready (e.g., from “0” to “1”) to indicate that there is sufficient current budget available to handle the next data burst.

In this example, the next data burst is received by Die0 610-3 of CH1 602-2. Die0 610-3 is associated with command sequence 620-3. Command sequence 620-3 includes C1 and C2. T1 follows C1 and T2′ follows C2. Command sequence 620-3 includes a data path operation (“data burst”) followed by C2. T2 follows C2, as described above with reference to FIG. 5. T2′ is the sum of T2 and the amount of time spent waiting for the PPM component to reserve the second amount of data path operation current budget. Thus, since CH1 602-2 has received the data burst before CH2 602-3, CH1 602-2 can utilize the second amount of data path operation current budget after T2′ (i.e., after the ASIC determines that the values of the corresponding budget ready status register bit and cache ready status register bit are both ready values). Moreover, Die1 610-4 is associated with command sequence 620-4. Command sequence 620-4 is similar to command sequence 620-2. Since the second amount of data path operation current budget has been reserved for CH1 602-2, Die1 610-4 can handle the data burst of command sequence 620-4 immediately.

With respect to CH2 602-3, as shown in FIG. 6B, the value of CH2 budget ready status register bit 630-3 goes from ready to busy upon the initiation of the data burst handled by Die0 610-3. This is because CH2 602-3 has to wait for the PPM component to reserve a third amount of data path operation current budget. As shown in FIG. 6B, once the PPM component has reserved the third amount of data path operation current budget, the value of the CH2 budget ready status register bit 630-3 goes from busy to ready to indicate that there is sufficient current budget to handle the next data burst.

In this example, the next data burst is received by Die0 610-5 of CH2 602-3. Die0 610-5 is associated with command sequence 620-5. Command sequence 620-5 includes C1 and C2. T1 follows C1 and T2″ follows C2. Command sequence 620-5 includes a data path operation (“data burst”) followed by C2. T2 follows C2. T2″ is the sum of T2 and the amount of time spent waiting for the PPM component to reserve the second amount of data path operation current budget and the third amount of data path operation current budget. Thus, CH2 602-3 can utilize the third amount of data path operation current budget after T2″ (i.e., after the ASIC determines that the values of the corresponding budget ready status register bit and cache ready status register bit are both ready values). Moreover, Die1 610-6 is associated with command sequence 620-6. Command sequence 620-6 is similar to command sequence 620-2. Since the third amount of data path operation current budget has been reserved for CH2 602-3, Die1 610-6 can handle the data burst of command sequence 620-4 immediately.

FIGS. 7A-7B are diagrams illustrating an example implementation of PPM with cache write operation current management, in accordance with some embodiments of the present disclosure. For example, FIG. 7A is a diagram 700A showing multiple channels (CH) including CH0 702-1, CH1 702-2 and CH2 702-3. Each of the channels is shown including two dies. For example, CH0 702-1 includes Die0 710-1 and Die1 710-2, CH1 702-2 includes Die0 710-3 and Die1 710-4, and CH2 702-3 includes Die0 710-5 and Die1 710-6. Each of the dies can correspond to a respective LUN. Although three channels and six dies are shown, the system can include any number of channels and/or dies.

In this illustrative example, with respect to CH0 702-1, Die0 710-1 is associated with command sequence 720-1. Command sequence 720-1 includes command block 3 (C3), a data path operation, and command block 4 (C4). In this example, the data path operation is a data burst (e.g., write burst). A third latency (T3) follows C4. T2 follows C2. Moreover, Die1 510-2 is associated with command sequence 520-2. Command sequence 520-2 is similar to command sequence 520-1.

C3 and C4 can each include one or more commands to enable cache programming. For example, C3 can include a load command (e.g., 80h command) for loading data after receiving an address (i.e., column and row address). C4 can include a cache program command that, after C3, can initiate a cache programming operation. Cache programming status can be determined from a cache ready status register bit (e.g., SR[6]) or an RB #pin. T3 is the busy time related to the cache programming (e.g., tCBSY or tPBSY).

With respect to CH0 702-1, in this example, it is assumed that an amount of data path operation current budget has been pre-reserved for CH 702-1. Because of this, as shown in FIG. 7B, the CH0 budget ready status register bit 740-1 is always ready (e.g., always “1”). Thus, incoming data bursts of command sequences 720-1 and 720-2 are received and handled immediately by Die0 710-1 and Die1 710-2, respectively (it is assumed that the cache ready status register bits of Die0 710-1 and Die 1 710-2 are ready (e.g., “1”)).

With respect to CH1 702-2 and CH2 702-3, as shown in FIG. 7B, the values of the CH1 budget ready status register bit 740-2 and the CH2 budget ready status register bit 740-3 each go from ready to busy (e.g., from “1” to “0”) upon the initiation of the data burst handled by Die0 710-1. This is because CH1 702-3 and CH2 702-3 have to wait for the PPM component to reserve a second amount of data path operation current budget. As shown in FIG. 7B, once the PPM component has reserved the second amount of data path operation current budget, the values of the CH1 budget ready status register bit 740-2 and the CH2 budget ready status register bit 740-3 each go from busy to ready (e.g., from “0” to “1”) to indicate that there is sufficient current budget available to handle the next data burst.

In this example, the next data burst is received by Die0 710-3 of CH1 702-2. Die0 710-3 is associated with command sequence 720-3, which is similar to command sequence 720-1. There is a delay (T4) 730-1 from C3 of command sequence 720-1 and C3 of command sequence 720-3. T4 730-1 corresponds to the amount of time for reserving the second amount of data path operation current budget. Thus, since CH1 702-2 has received a data burst before CH2 702-3, CH1 702-2 can utilize the second amount of data path operation current budget after T4 730-1 (i.e., after the ASIC determines that the values of the corresponding budget ready status register bit and cache ready status register bit are both ready values). Moreover, Die1 710-4 is associated with command sequence 720-4. Command sequence 720-4 is similar to command sequence 720-2. Since the second amount of data path operation current budget has been reserved for CH1 702-2, Die1 710-4 can handle the data bursts of command sequence 720-4 immediately.

With respect to CH2 702-3, as shown in FIG. 7B, the value of CH2 budget ready status register bit 740-3 goes from ready to busy upon the initiation of the data burst handled by Die0 710-3. This is because CH2 702-3 has to wait for the PPM component to reserve a third amount of data path operation current budget. As shown in FIG. 7B, once the PPM component has reserved the third amount of data path operation current budget, the value of the CH2 budget ready status register bit 740-3 goes from busy to ready to indicate that there is sufficient current budget to handle the next data burst.

In this example, the next data burst is received by Die0 710-5 of CH2 702-3. Die0 710-5 is associated with command sequence 720-5, which is similar to command sequence 720-1. There is a delay (T5) 730-2 from C3 of command sequence 720-1 and C3 of command sequence 720-5. T5 730-1 corresponds to the amount of time for reserving the third amount of data path operation current budget. Thus, CH2 702-3 can utilize the third amount of data path operation current budget after T5 730-2 (i.e., after the ASIC determines that the values of the corresponding budget ready status register bit and cache ready status register bit are both ready values). Moreover, Die1 710-6 is associated with command sequence 720-6. Command sequence 720-6 is similar to command sequence 720-2. Since the third amount of data path operation current budget has been reserved for CH2 702-3, Die1 710-6 can handle the data bursts of command sequence 720-6 immediately.

FIGS. 8A-8B are diagrams illustrating an example implementation of PPM with mixed load dynamic data path operation current budget management, in accordance with some embodiments of the present disclosure. More specifically, FIGS. 8A-8B illustrate a cache write implementation. For example, FIG. 8A is a diagram 700A showing multiple channels (CH) including CH0 802-1, CH1 802-2 and CH2 802-3. Each of the channels is shown including two dies. For example, CH0 802-1 includes Die0 810-1 and Die1 810-2, CH1 802-2 includes Die0 810-3 and Die1 810-4, and CH2 802-3 includes Die0 810-5 and Die1 810-6. Each of the dies can correspond to a respective LUN. Although three channels and six dies are shown, the system can include any number of channels and/or dies.

In this illustrative example, with respect to CH0 802-1, Die0 810-1 is associated with command sequence 820-1. Command sequence 820-1 includes C3, a data path operation, and C4. In this example, the data path operation is a data burst (e.g., write burst). T3 follows C4. T2 follows C2. Moreover, Die1 810-2 is associated with command sequence 520-2. Command sequence 820-2 is similar to command sequence 820-1. Further details regarding command sequences 820-1 and 820-2 are described above with reference to FIG. 7A.

With respect to CH0 802-1, in this example, it is assumed that an amount of data path operation current budget has been pre-reserved for CH 802-1. Because of this, as shown in FIG. 8B, the CH0 budget ready status register bit 840-1 is always ready (e.g., always “1”). Thus, incoming data bursts of command sequences 820-1 and 820-2 are received and handled immediately by Die0 810-1 and Die1 810-2, respectively (it is assumed that the cache ready status register bits of Die0 810-1 and Die 1 810-2 are ready (e.g., “1”)).

With respect to CH1 802-2 and CH2 802-3, as shown in FIG. 8B, the values of the CH1 budget ready status register bit 840-2 and the CH2 budget ready status register bit 840-3 each go from ready to busy (e.g., from “1” to “0”) upon the initiation of the data burst handled by Die0 810-1. This is because CH1 802-3 and CH2 802-3 have to wait for the PPM component to reserve a second amount of data path operation current budget. As shown in FIG. 8B, once the PPM component has reserved the second amount of data path operation current budget, the values of the CH1 budget ready status register bit 840-2 and the CH2 budget ready status register bit 840-3 each go from busy to ready (e.g., from “0” to “1”) to indicate that there is sufficient current budget available to handle the next data burst.

In this example, the next data burst is received by Die0 810-5 of CH2 802-3. Die0 810-5 is associated with command sequence 820-5, which is similar to command sequence 820-1. T4 830 exists between C3 of command sequence 820-1 and C3 of command sequence 820-5 (similar to T4 730-1 described above with reference to FIG. 7A). Thus, since CH2 802-5 has received a data burst before CH1 802-2, CH2 802-3 can utilize the second amount of data path operation current budget after T4 830 (i.e., after the ASIC determines that the values of the corresponding budget ready status register bit and cache ready status register bit are both ready values). Moreover, Die1 810-6 is associated with command sequence 820-6. Command sequence 820-6 is similar to command sequence 820-2. Since the second amount of data path operation current budget has been reserved for CH2 802-3, Die1 810-6 can handle the data bursts of command sequence 820-6 immediately.

With respect to CH1 802-2, as shown in FIG. 8B, the value of CH1 budget ready status register bit 840-2 goes from ready to busy upon the initiation of the data burst handled by Die0 810-5. This is because CH1 802-2 has to wait for the PPM component to reserve a third amount of data path operation current budget. As shown in FIG. 8B, once the PPM component has reserved the third amount of data path operation current budget, the value of the CH1 budget ready status register bit 840-2 goes from busy to ready to indicate that there is sufficient current budget to handle the next data burst.

In this example, the next data burst is received by Die0 810-3 of CH1 802-2. Die0 810-3 is associated with command sequence 820-3 and Die1 810-4 is associated with command sequence 820-4. Command sequence 820-3 is similar to, e.g., command sequence 620-1 of FIG. 6A and command sequence 820-4 is similar to, e.g., command sequence 620-2 of FIG. 6A. CH1 802-2 can utilize the third amount of data path operation current budget (i.e., after the ASIC determines that the values of the corresponding budget ready status register bit and cache ready status register bit are both ready values). Since the third amount of data path operation current budget has been reserved for CH1 802-3, Die1 810-4 can handle the data burst of command sequence 820-4 immediately.

In the embodiments described above with reference to FIGS. 5-8B, the PPM component can detect the preamble of a data path operation (e.g., data burst) with respect to a die of a channel, and check if there is available budget reserved for the channel to handle the data path operation in response to detecting the preamble. Moreover, the PPM component can detect the postamble of the data path operation, and determine whether to release the budget reserved to the channel after detecting the postamble. In some embodiments, the budget can be released immediately after detecting the postamble. To increase efficiency by prevent frequent releasing and reservation of current budget, the PPM component can delay the release of the current budget reserved to a channel for a threshold amount of time. For example, the PPM component can utilize a filter defining the threshold amount of time. More specifically, if the PPM component does not detect the preamble of next data path operation associated with the channel (e.g., a data path operation with respect to another die of the channel) within the threshold amount of time (e.g., less than or equal to the threshold amount of time), then the PPM component will release the current budget reserved for the channel. Therefore, the channel can maintain its current budget to handle data path operations that are detected within the threshold amount of time from the most recent data path operation to be completed.

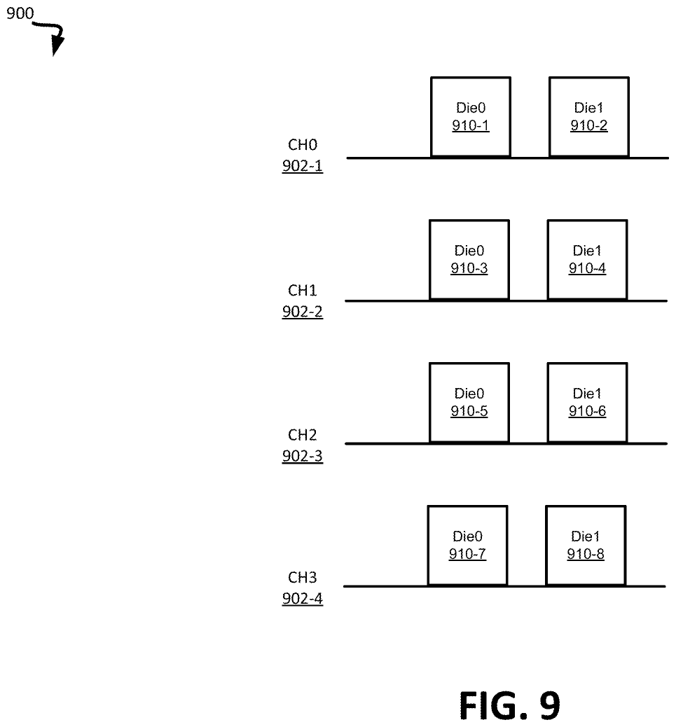

FIG. 9 is a diagram 900 illustrating an example status register bit and budget threshold interaction, in accordance with some embodiments of the present disclosure. The diagram 900 shows a memory sub-system including channels CH0 902-1 through CH3 902-4. CH 902-1 includes Die0 910-1 and Die1 910-2. CH 902-2 includes Die0 910-3 and Die1 910-4. CH 902-3 includes Die0 910-5 and Die1 910-6. CH 902-4 includes Die0 910-7 and Die1 910-8. Thus, the memory sub-system can have two dies per channel. For example, the memory sub-system can be a UFS device.

In a precondition case, it is assumed that an amount of current budget for a data path operation (e.g., data burst) is pre-reserved by CH0 902-1. For example, the budget ready status register bit for each of the dies 910-1 through 910-8 can be at the set value (e.g., “1”). If the total current budget is A and the amount of current budget for the data path operation is B, then the current budget for memory array operations, C, can be at most A-B (i.e., C≤A-B).

Assume now that a data burst is performed with respect a die of CH0 902-1 (e.g., Die1 910-2). The amount of current budget, B, can be sent to the other dies in a token ring (e.g., via the HC #bus). The budget ready status register bit for CH0 902-1 can be at the set value. The budget ready status register bits for the other channels CH1 902-2 through CH3 902-4 can depend on whether the current budget for memory array operations, C, satisfies a threshold condition (e.g., C≤A-B)

If C satisfies the threshold condition (e.g., C≤A-B), this means that the other channels CH1 902-2 through CH3 902-4 need not wait for current budget to be released. Accordingly, the budget ready status register bit for the other channels CH1 902-2 through CH3 902-4 can be set at the set value.

If C does not satisfy the threshold condition (e.g., C≥A-B), this means that there is insufficient current budget for the other channels 902-2 through 902-4 (i.e., there is current overbudgeting). The budget ready status register bit for the other channels CH1 902-2 through CH3 902-4 can be set at the reset value (e.g., “0”), at least until enough current budget is released to satisfy the threshold condition (e.g., C≤A-B).

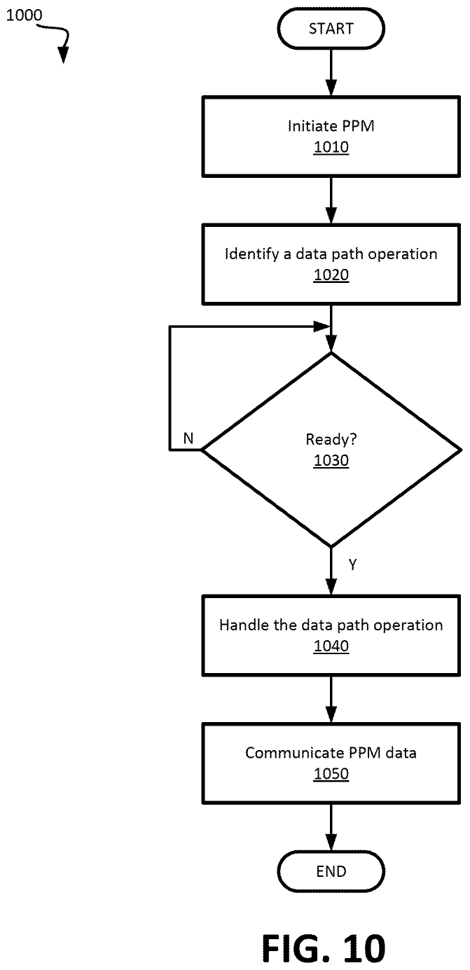

FIG. 10 is a flow diagram of an example method 1000 to implement PPM with dynamic data path operation current budget management, in accordance with some embodiments of the present disclosure. The method 1000 can be performed by control logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 1000 is performed by the local media controller 135 and/or the PPM component 137 of FIGS. 1A-1B. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 1010, peak power management (PPM) is initialized. For example, control logic can initialize PPM with respect to a plurality of memory dies (“dies”). The plurality of dies can be included within a PPM network of a memory sub-system, such as the memory sub-system 110. The plurality of dies can form a token ring group. The token ring group is an ordered group of dies. The token ring group can include a primary die and a set of secondary dies. For example, the first die of the token ring group can be assigned to be the primary die. The primary die can be responsible for controlling the passing of a PPM token using a clock signal (ICLK).

The memory device can include a plurality of channels, and each channel of the plurality of channels can include a respective set of dies of the plurality of dies. Illustratively, each channel of the plurality of channels can include a pair of dies (e.g., Die0 and Die1).

Initializing PPM can include pre-reserving, to a channel of the plurality of channels, an amount of current budget associated with a data path operation (e.g., a single channel). More specifically, pre-reserving the amount of current budget to the channel can include allocating a pre-reserved amount of current budget to the channel. The data path operation can be an ICC4 operation. In some embodiments, the data path operation is a data burst. For example, the data burst can be a read burst. As another example, the data burst can be a write burst.

At operation 1020, a data path operation is identified. For example, control logic can identify the data path operation with respect a die associated with a channel. In some embodiments, the channel is the channel having the pre-reserved amount of current budget. In some embodiments, the channel is another channel has not reserved an amount of current budget associated with the data path operation.

Upon identifying the data path operation, at operation 1030, a determination is made. For example, control logic can determine, based on at least one value derived from a current budget ready status and a cache ready status, whether the channel is ready for the die to handle the data path operation. More specifically, the at least one value can be obtained from a set of status register bits. For example, determining whether the channel is ready for the die to handle the data path operation can include polling the set of status register bits to obtain the least one value.

In some embodiments, the set of status register bits includes a current budget ready status register bit and a cache ready status register bit (i.e., a ready/busy status register bit). The current budget ready status register bit can be an extended status register bit. The at least one value can include a first value corresponding to the current budget ready status register bit and a second value corresponding to the cache ready status register bit. The first value can indicate whether the data path operation current budget, assigned to a channel, is ready for an incoming data path operation (e.g., data burst). The current budget ready status register bit is synchronized across all dies of a given channel. For example, if the first value is a reset value (e.g., “0”), this indicates that there is insufficient available data path operation current budget assigned to the channel to handle a data path operation (e.g., data burst). If the first value is a set value (e.g., “1”), this indicates that there is sufficient available data path operation current budget assigned to the channel to handle a data path operation. The second value can indicate whether an internal cache is ready for handling a data path operation (e.g., data burst). For example, the cache ready status register bit can correspond to pin SR[6]. The second value can correspond to the value of the ready/busy signal (RB #). More specifically, the second value can indicate “busy” (e.g., “0”) or “ready” (e.g., “1”). Thus, the cache ready status register bit can return the ready value when the internal cache is available to receive new data. Determining whether the channel is ready can include determining whether the first value is the set value and the second value is the ready value (e.g., both values are “1”). More specifically, the set of status register pits can be polled to check the first value and the second value. Accordingly, the channel can be determined to be ready in response to determining that the first value is the set value and the second value is the ready value.

In some embodiments, the set of status register bits includes a modified cache ready status register bit. The at least one value can include a value corresponding to the modified cache ready status register bit determined from the cache ready status and the current budget ready status. More specifically, the memory device can internally generate the value corresponding to the modified cache ready status register bit by implementing AND logic, such that the value will be a ready value when both the current budget ready status and the cache ready status are both set or ready (e.g., the modified cache ready status register bit has a value of “1”). Determining whether the channel is ready can include determining whether the value corresponding to the modified cache ready status register bit is the ready value. More specifically, the set of status register bits can be polled to check the value corresponding to the modified cache ready status register bit. Accordingly, the channel can be determined to be ready in response to determining that the value corresponding to the modified cache ready status register bit is the ready value (e.g., “1”).

If the channel is not ready, then control logic can continue to determine whether the channel is ready. For example, continuing to determine whether the channel is ready can include continuing to poll the set of status register bits. Otherwise, if the channel is ready, then the data path operation can be handled at operation 1040. For example, control logic can cause the data path operation to be handled by the die. Causing the data path operation to be handled can include causing the current budget allocated to the channel to be consumed by the die.

At operation 1050, PPM data is communicated. For example, control logic can cause the PPM data to be communicated to the other dies of the plurality of dies. More specifically, control logic can cause the PPM data to be communicated to the other dies during a current PPM cycle via their respective PPM components. The PPM data can include current consumption data related to an amount of current consumed during execution of the data path operation. Further details regarding operations 1010-1050 are described above with reference to FIGS. 1A-9.

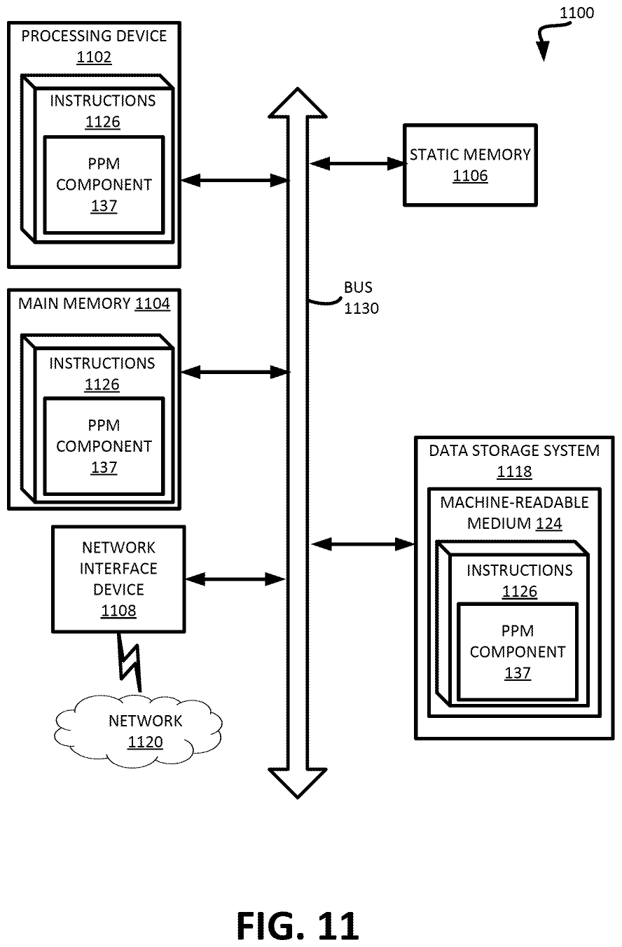

FIG. 11 illustrates an example machine of a computer system 1100 within which a set of instructions, for causing the machine to perform any one or more of the methodologies discussed herein, can be executed. In some embodiments, the computer system 1100 can correspond to a host system (e.g., the host system 120 of FIG. 1A) that includes, is coupled to, or utilizes a memory sub-system (e.g., the memory sub-system 110 of FIG. 1A) or can be used to perform the operations of a controller (e.g., to execute an operating system to perform operations corresponding to the local media controller 135 and/or the PPM component 137 of FIG. 1A). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a memory cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 1100 includes a processing device 1102, a main memory 1104 (e.g., read-only memory (ROM), flash memory, dynamic random access memory (DRAM) such as synchronous DRAM (SDRAM) or RDRAM, etc.), a static memory 1106 (e.g., flash memory, static random access memory (SRAM), etc.), and a data storage system 1118, which communicate with each other via a bus 1130.

Processing device 1102 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 1102 can also be one or more special-purpose processing devices such as an application specific integrated circuit (ASIC), a field programmable gate array (FPGA), a digital signal processor (DSP), network processor, or the like. The processing device 1102 is configured to execute instructions 1126 for performing the operations and steps discussed herein. The computer system 1100 can further include a network interface device 1108 to communicate over the network 1120.

The data storage system 1118 can include a machine-readable storage medium 1124 (also known as a computer-readable medium) on which is stored one or more sets of instructions 1126 or software embodying any one or more of the methodologies or functions described herein. The instructions 1126 can also reside, completely or at least partially, within the main memory 1104 and/or within the processing device 1102 during execution thereof by the computer system 1100, the main memory 1104 and the processing device 1102 also constituting machine-readable storage media. The machine-readable storage medium 1124, data storage system 1118, and/or main memory 1104 can correspond to the memory sub-system 110 of FIG. 1A.

In one embodiment, the instructions 1126 include instructions to implement functionality corresponding to a local media controller and/or PPM component (e.g., the local media controller 135 and/or the PPM component 137 of FIG. 1A). While the machine-readable storage medium 1124 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A memory device comprising:
a plurality of memory dies, each memory die of the plurality of memory dies comprising;
a memory array; and
control logic, operatively coupled with the memory array, to perform operations comprising:
identifying a data path operation with respect to the memory die, wherein the memory die is associated with a channel;
determining, based on at least one value derived from a current budget ready status and a cache ready status, whether the channel is ready for the memory die to handle the data path operation; and
in response to determining that the channel is ready for the memory die to handle the data path operation, causing the data path operation to be handled by the memory die.

2. The memory device of claim 1, wherein the operations further comprise pre-reserving, to the channel, an amount of current budget associated with the data path operation.

3. The memory device of claim 1, wherein the at least one value comprises a first value corresponding to a current budget ready status register bit and a second value corresponding to a cache ready status register bit, and wherein the current budget ready status register bit is an extended status register bit.

4. The memory device of claim 3, wherein determining whether the channel is ready for the memory die to handle the data path operation comprises determining whether the first value is a set value and the second value is a ready value.

5. The memory device of claim 1, wherein the at least one value comprises a value corresponding to a modified cache ready status register bit determined from the cache ready status and the current budget ready status, and wherein determining whether the channel is ready for the memory die to handle the data path operation comprises determining whether the value corresponding to the modified cache ready status register bit is a ready value.

6. The memory device of claim 1, wherein the data path operation is a data burst.

7. The memory device of claim 1, wherein the operations further comprise causing PPM data to be communicated to other memory dies of the plurality of memory dies, and wherein the PPM data comprises current consumption data related to an amount of current consumed during execution of the data path operation.

8. A method comprising:
identifying, by a processing device, a data path operation with respect to a memory die of a plurality of memory dies of a memory device, wherein the memory die is associated with a channel;
determining, by the processing device based on at least one value derived from a current budget ready status and a cache ready status, whether the channel is ready for the memory die to handle the data path operation; and
in response to determining that the channel is ready for the memory die to handle the data path operation, causing, by the processing device, the data path operation to be handled by the memory die.

9. The method of claim 8, further comprising pre-reserving, by the processing device to the channel, an amount of current budget associated with the data path operation.

10. The method of claim 8, wherein the at least one value comprises a first value corresponding to a current budget ready status register bit and a second value corresponding to a cache ready status register bit, and wherein the current budget ready status register bit is an extended status register bit.

11. The method of claim 10, wherein determining whether the channel is ready for the memory die to handle the data path operation comprises determining whether the first value is a set value and the second value is a ready value.

12. The method of claim 8, wherein the at least one value comprises a value corresponding to a modified cache ready status register bit determined from the cache ready status and the current budget ready status, and wherein determining whether the channel is ready for the memory die to handle the data path operation comprises determining whether the value corresponding to the modified cache ready status register bit is a ready value.

13. The method of claim 8, wherein the data path operation is a data burst.

14. The method of claim 8, further comprising causing, by the processing device, PPM data to be communicated to other memory dies of the plurality of memory dies, wherein the PPM data comprises current consumption data related to an amount of current consumed during execution of the data path operation.

15. A non-transitory computer-readable storage medium comprising instructions that, when executed by a processing device, cause the processing device to perform operations comprising:
initializing peak power management (PPM) with respect to a plurality of memory dies, wherein initializing PPM comprises pre-reserving, to a single channel of a plurality of channels, an amount of current budget associated with a data path operation, and wherein each channel of the plurality of channels is associated with a respective set of memory dies of the plurality of memory dies;
polling a set of status register bits to obtain at least one value derived from a current budget ready status and a cache budget ready status;
determining, based on the at least one value, whether a given channel of the plurality of channels is ready for a memory die associated with the given channel to handle an incoming data path operation; and
in response to determining that the given channel is not ready for the memory die to handle the incoming data path operation, continuing to poll the set of status register bits.

16. The non-transitory computer-readable storage medium of claim 15, wherein the set of status register bits comprises a current budget ready status register bit and a cache ready status register bit, wherein the at least one value comprises a first value corresponding to the current budget ready status register bit and a second value corresponding to the cache ready status register bit, and wherein the current budget ready status register bit is an extended status register bit.

17. The non-transitory computer-readable storage medium of claim 16, wherein determining whether the channel is ready for the memory die to handle the data path operation comprises determining whether the first value is a set value and the second value is a ready value.

18. The non-transitory computer-readable storage medium of claim 15, wherein the set of status register bits comprises a modified cache ready status register bit, wherein the at least one value comprises a value corresponding to the modified cache ready status register bit determined from the cache ready status and the current budget ready status, and wherein determining whether the channel is ready for the memory die to handle the data path operation comprises determining whether the value corresponding to the modified cache ready status register bit is a ready value.

19. The non-transitory computer-readable storage medium of claim 15, wherein the data path operation is a data burst.

20. The non-transitory computer-readable storage medium of claim 15, wherein the operations further comprise, in response to determining that the given channel is ready for the memory die to handle the incoming data path operation:
causing the data path operation to be handled by the memory die; and
causing PPM data to be communicated to other memory dies of the plurality of memory dies, and wherein the PPM data comprises current consumption data related to the amount of current consumed during execution of the data path operation.
